(19) United States
(12) Patent Application Publication
(10) Pub. No.: US 2019/0099894 A1
(43) Pub. Date: Apr. 4, 2019

(54) METHOD AND APPARATUS FOR BALANCING BOXER TOY

(71) Applicant: Innovation First, Inc., Greenville, TX (US)

(72) Inventors: Robert H. Mimlitch, III, Greenville, TX (US); Mitch Randall, Longmont, CA (US); Thomas Charles Glick, Dallas, TX (US); Douglas Michael Galletti, Allen, TX (US); Bryan James Culver, Greenville, TX (US); David Anthony Norman, Greenville, TX (US)

(73) Assignee: Innovation First, Inc., Greenville, TX (US)

(21) Appl. No.: 16/148,423

(22) Filed: Oct. 1, 2018

Related U.S. Application Data
(60) Provisional application No. 62/566,808, filed on Oct. 2, 2017.

(51) Int. Cl. B25J 11/00; B25J 5/00; B25J 9/16

(52) U.S. Cl. CPC B25J 11/003; B25J 9/1664; B25J 9/1607; B25J 5/007

(57) ABSTRACT

The present invention includes a pair of boxing robots. Each robot includes at least one wheel and at least one arm controllable through a control system on the robot that is in communication with a user control unit. The control system has at least one axis of inertial sensing to support balancing of the robot. Preprogrammed algorithms are configured to include a balance algorithm to (a) maintain the robot upright during movement and actions, (b) maintain the robot upright upon sensing impact or force onto the robot, (c) cause the robot to fall prone upon sensing a strong impact or force (defined above a threshold) or sensing repeated impacts above a threshold number, and (d) create specified movement to mimic swagger, loss of energy, and additional wobble to imitate dazing. A set of preprogrammed instructions to (a) control wheels to move the robot, (b) control arms to mimic punching.

### CROSS-REFERENCES TO RELATED APPLICATIONS

The present application claims the benefit of U.S. Provisional Application Ser. No. 62/566,808, filed on Oct. 2, 2017 and is incorporated herein by reference.

### FIELD OF THE INVENTION

The present invention relates to boxing robots and more particularly to balancing boxing robots designed to move on a surface with the aid of wheeled legs.

### BACKGROUND OF THE INVENTION

Balancing robots are well known. Such devices rely on a two-wheel drive mechanism and an algorithm to keep the robot generally upright while standing or moving. These devices can be configured in a way that would never fall over. These devices can also be adapted into boxing robots that can stay upright to varying degrees while taking and receiving punches. As such, the ability to create a pair of boxing robots for kids that simulates a boxing match and that leads to a single winning robot is highly desired. Not only does the robot have to be able to counter the punches delivered it must monitor received punches such that the robot can exhibit almost human boxing characteristics such as fatigue or exhaustion, as well as being configured to almost fall then regain balance, and fall and remain prone indicating a loss of the fight. The present invention builds upon the prior art to solve one or more of these issues.

### SUMMARY OF THE INVENTION

The robots are each designed with one or more of the following characteristics
two motors and two wheels to drive and balance
One or more motors driving Punching Arms
Remote wireless steering input
Remote wireless punch control
Balancing Algorithm
balances while providing wheel drive from a remote controller
counts disturbances in the balance from being punched
ignores disturbances in the balance from punching
counts the shock of disturbances as punches are taken
as the robot takes more punches, it adjusts the balance algorithm to do one or more of the following in increasing amounts:
   add more wobble to the balance
   add randomness to the users steering
   add sluggishness to the driving
   add sluggishness to the punching
eventually a punch taken will trigger a fall that can be one of the following ways:
   force a face plant forwards
   a force a fall backwards
   stop balancing and slow fall
   spin left or right then fall.

### BRIEF DESCRIPTION OF THE DRAWINGS

For a fuller understanding of the nature of the present invention, reference should be made to the following detailed description taken in conjunction with the accompanying drawings in which:

FIG. 1 illustrates a perspective view of a balancing boxing robot in accordance to an embodiment of the invention;

FIG. 2 illustrates a schematic of the controller used in an embodiment of the balancing boxing robot;

FIG. 3 is a perspective view of a controlled mechanical arm used in an embodiment of the balancing robot;

FIG. 4 illustrates a schematic of a balancing algorithm used in an embodiment of the balancing boxing robot;

FIG. 5 illustrates a schematic of an erratic injector algorithm used in an embodiment of the balancing boxing robot;

FIG. 6 illustrates a schematic of a damage detector algorithm used in an embodiment of the balancing boxing robot;

FIG. 7 illustrates a balancing boxing robot in accordance with another embodiment of the invention;

FIG. 8 illustrates a balancing boxing robot in accordance with another embodiment of the invention;

FIG. 9 illustrates a balancing boxing robot in accordance with another embodiment of the invention;

FIG. 10 illustrates a side profile of a controlled mechanical arm used in an embodiment of the balancing boxing robot;

FIG. 11 illustrates another side profile of a controlled mechanical arm used in an embodiment of the balancing boxing robot;

FIG. 12 illustrates another side profile of a controlled mechanical arm used in an embodiment of the balancing boxing robot;

FIG. 13 illustrates another side profile of a controlled mechanical arm used in an embodiment of the balancing boxing robot;

FIG. 14 illustrates a balancing boxing robot in accordance with another embodiment of the invention;

FIG. 15 illustrates a balancing boxing robot in accordance with another embodiment of the invention;

FIG. 16 illustrates the upper torso of a balancing boxing robot in accordance with another embodiment of the invention;

FIG. 17 illustrates the upper torso of a balancing boxing robot in accordance with another embodiment of the invention;

FIG. 18 illustrates a controlled mechanical arm used in an embodiment of the balancing boxing robot;

FIG. 19 illustrates a controlled mechanical arm used in an embodiment of the balancing boxing robot;

FIG. 20 illustrates an exploded view of a controlled mechanical arm used in an embodiment of the balancing boxing robot;

FIG. 21 illustrates an exploded view of a controlled mechanical arm used in an embodiment of the balancing boxing robot;

FIGS. 22A, 22B, 22C illustrates electrical schematics of a control mechanism used in an embodiment of the balancing boxing robot;

FIG. 23A is an electrical schematic of a 3-axis magnetometer used in an embodiment of the balancing boxing robot;

FIG. 23B is an electrical schematic of a 3-axis gyroscope 3 Axis accelerometer used in an embodiment of the balancing boxing robot;

FIGS. 24A, 24B, 24C is an electrical schematic used in an embodiment of the balancing boxing robot;

FIGS. 25A, 25B, 25C, 25D are electrical schematics used to control the motors in an embodiment of the balancing boxing robot;

FIG. 26 is illustrates a balancing boxing robot in accordance with another embodiment of the invention;

FIG. 27 illustrates a balancing boxing robot in accordance with another embodiment of the invention;

FIG. 28 illustrates a balancing boxing robot in accordance with another embodiment of the invention;

FIG. 29 illustrates a balancing boxing robot in accordance with another embodiment of the invention;

FIG. 30 is a punch detector algorithm used in an embodiment of the balancing boxing robot;

FIG. 31 is a graph used with the punch detector algorithm;

FIG. 32 is an illustration of position encoders on the wheels used in an embodiment of the balancing boxing robot;

FIG. 33 illustrates a schematic using an EKF Filter in an embodiment of the balancing boxing robot;

FIG. 34 illustrates a instantiation algorithm used in an embodiment of the balancing boxing robot; and

FIG. 35 is a gear train used in an embodiment of the balancing boxing robot.

### DETAILED EXPLANATION OF THE INVENTION AND NEW METHOD

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the claims by the embodiments illustrated.

Referring now to the Figures, robot 100 is roughly human in shape. The shape is cosmetic in selection to resemble a mix of a human boxer and humanoid robots.

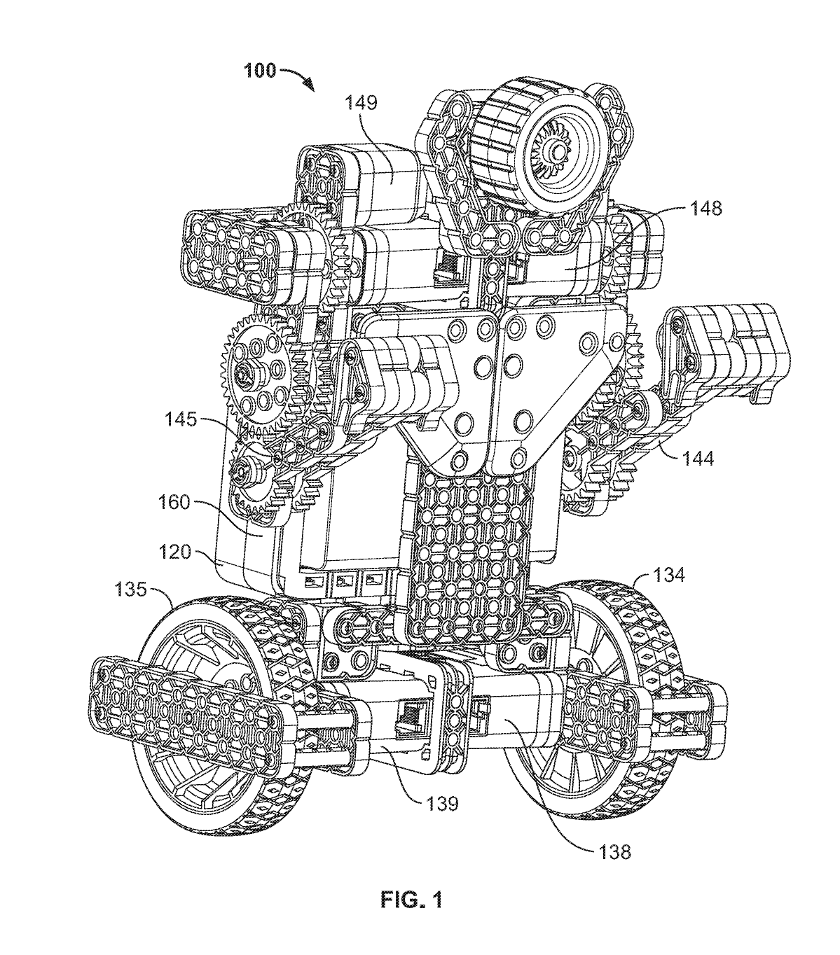

In the preferred embodiment, robot 100 includes a body 102 with two motors 138, 139, two actuators 148, 149, two articulated arms 144, 145, two wheels 134, 135, battery pack 160, and controller 120. Left wheel 134 is driven by left drive motor 138, and right wheel 135 is driven by right motor 139. Left articulated arm 144 is driven by left actuator 148, and right articulated arm 145 is driven by right actuator 149. Controller 120 is electrically connected to and powered by battery pack 160. Controller 120 is further electrically connected (not shown in FIG. 1) to left drive motor 138, right drive motor 139, left arm actuator 148, and right arm actuator 149. Controller 120 provides signals through said electrical connections as required to maintain the balance of the robot 100 against gravity and communicate with a user device 300 to at times initiate arm actuation and to navigate/move the robot 100 about a surface or playing field.

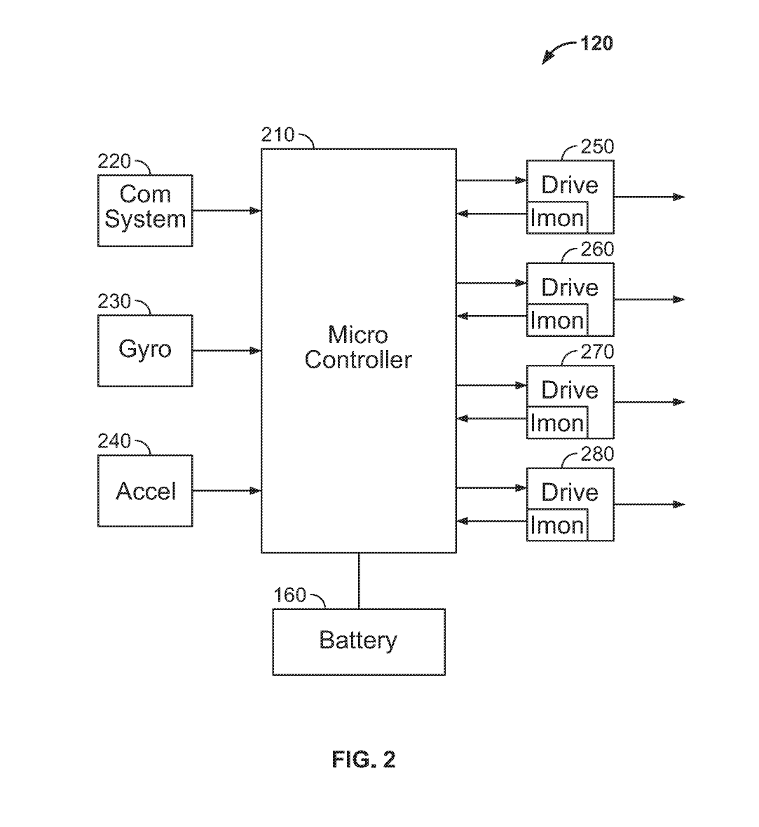

Referring now to FIG. 2, controller 120 is comprised of microcontroller 210 electrically connected and in communication with several subsystems 220, 230, 240, 250, 260, 270, 280. Communication system 220 provides communication with user device 300 such as to receive directives from user device 300 and such as to provide status and/or telemetry to user device 300.

Gyroscope subsystem 230 includes a gyroscopic sensor and/or components that provides inertial gyroscopic rates to microcontroller 210 such as is required to perform various algorithms for the functioning of robot 100. Accelerometer subsystem 240 includes an accelerometer sensor and/or components that provides inertial acceleration measurements to microcontroller 210 to be used for robot 100 functionality such as punch detection.

Four (4) high power drivers 250, 260, 270, 280 are employed to facilitate the control of drive motors 138, 139, and arm actuators 148, 149. Power drivers 250, 260, 270, 280 include current monitor subsystems (imon referenced in FIG. 2) to allow microcontroller 210 to have access to timely measurements of the current draw of the loads (138, 139, 148, 149) that are being driven.

Battery 160 provides power to controller 120. In addition, microcontroller 210 provides a means of measuring the voltage of battery pack 160 to facilitate functionality of robot 100.

Robot 100 performs self-balancing by virtue of the subsystems and firmware embodied within. Self-balancing is well known in the field of robotics. The choice to use self-balancing is based on several factors:
resembles a dancing boxer maintaining his balance,
approximates a human's two legs,
allows for wobbling and falling, and/or
visually shows the force of punches by the tilt angle at the moment of the punch.

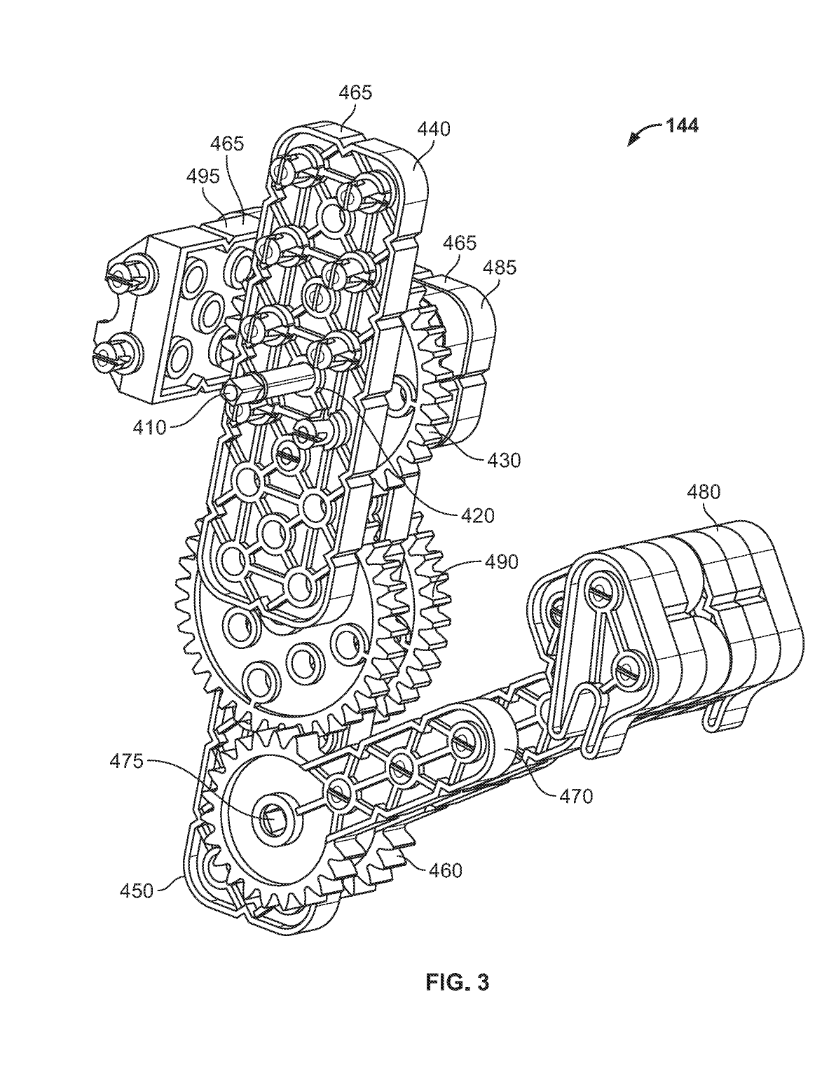

Referring now also to FIG. 3, the mechanics of articulated arms 144, 145 are designed to provide both extended and retracted positions similar to that of a human. The motion of articulated arms 144, 145 is designed to resemble a punch. Left articulated arm 144 is identical in operation to right articulated arm 145 except for being the mirror image. For the purpose of specification, the description of the operation of left articulated arm 144 shall be assumed to suffice in the understanding of the operation of right articulated arm 145.

For left articulated arm 144, shoulder assembly is comprised of rigidly connected shoulder members inner shoulder 440, outer shoulder 485, and rear shoulder 495. Shoulder assembly 465 is rigidly connected to the main body of robot 100 and serves to form the support structure portion of articulated arm 144. Shaft 410 is rotatably mounted in shoulder assembly 440, 485, 495 through rotational bearing 420. In addition, shaft 410 is rigidly connected to bicep 450 such that a counter-clockwise rotation of shaft 410 as viewed facing the annotated face of shaft 410 causes elbow joint 475 of bicep 450 to swing outward from robot 100 body about the axis of shaft 410. Shoulder gear 430 is rigidly fixed to shoulder assembly 440, 485, 490 and does not move with respect to robot 100 body. Idler gears 490 are rotationally mounted on bicep 450 such that they rotate freely on a bearing (not visible) in bicep 450. However, idler pair 490 is arranged to engage with fixed shoulder gear 490. Forearm gear pair 460 is rotationally mounted on bicep 450 at elbow joint 475 and is rigid with respect to forearm 470. Forearm gear pair 460 is arranged to engage with idler gear pair 490. Thus when shaft 410 rotates in bearing 420 in a counter-clockwise direction as viewed facing the annotated face of shaft 410, elbow joint 475 of bicep 450 swings away from robot 100 body with shoulder gear 430, idler gear pair 490, and forearm gear pair 460 engaged in such a way as to cause forearm 470 to extend away from robot 100 body, thus causing fist 480 to “throw a punch”. In operation, shaft 410 is driven by left actuator 148, which is rigidly fixed to robot 100 body. Various gear ratios may be used to provide variations on essentially the same extension motion.

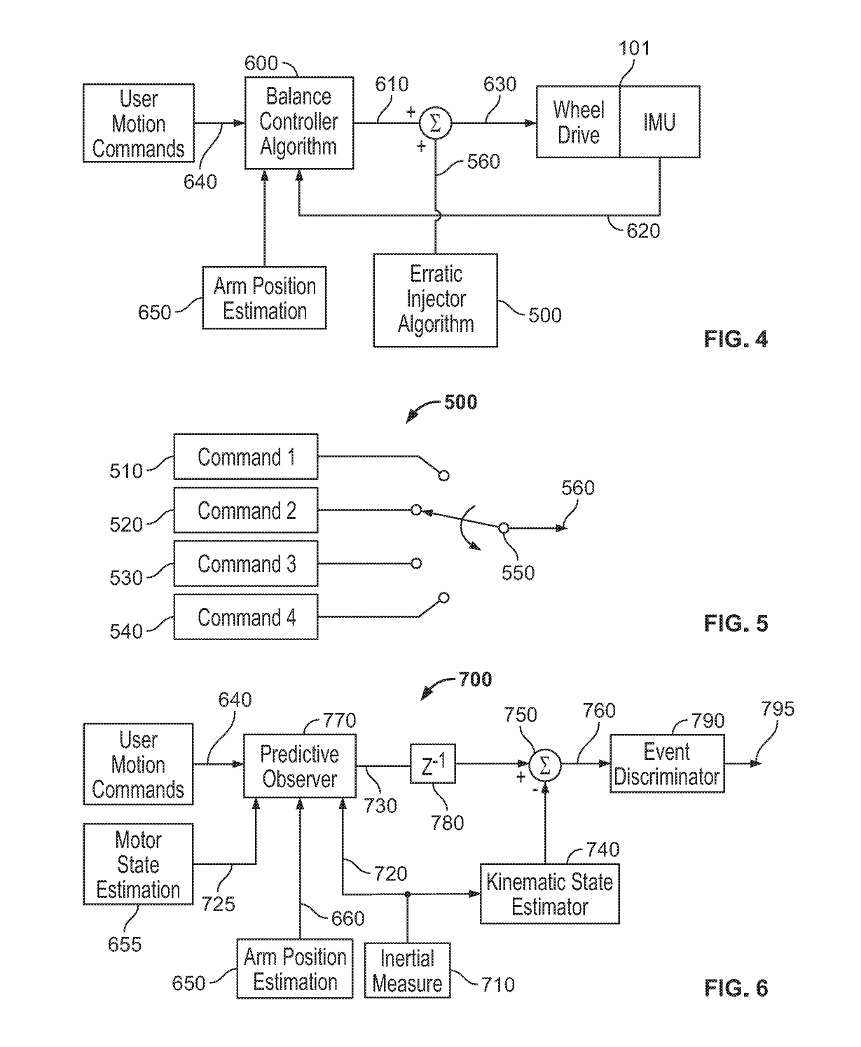

Referring now to FIG. 4, balancing algorithms are fine tuned to create very stable smooth motion. In an effort to create realism, to make the robot seem alive and sentient, an erratic injector algorithm 500 has been created and added to the balance controller algorithm 600. User motion commands 640 and Inertial Measurement signals 620 are operated on by balance controller algorithm 600 to create balance controller output 610. Erratic injector algorithm 500 creates erratic output 560 which is added to balance controller output 610 to become wheel drive input 630.

Referring now also to FIG. 6, erratic injector algorithm 500 is comprised of a sequencer 550 that provides output 560 based on a sequence of commands 510, 520, 530, 540. Commands 510, 520, 530, 540 specify, but are not limited to specifying, drive motor 138, 139 commands, actuator 148, 149 commands, angle offset commands, time duration information, and sequence count. Sequencer 550 may operate at a regular interval, or operate at a pseudorandom interval, or may operate at an interval provided by commands 510, 520, 530, 540.

The goal is to create a robot that looks like a boxer dancing, bobbing, and weaving without the user doing anything. These basic movements need to be automatic or appear automatically when based on responses from inputs during fighting. This is done by adding the new and unique erratic injector algorithm 500 into the balance algorithm 600.

The erratic injector algorithm adds small amounts of forward or reverse movement to the output of the balance algorithm. The direction and time can both be varied. The extent to which they can be varied depends on the robot's dynamics. The result of randomness on both wheels independently is random extra motion forward, reverse, right and left. By tuning the randomness to bias towards a pattern, the robot can look like it's doing a slight dance. This randomness can continue not only when the robot is not commanded to move, but also while the robot is moving. This makes even straight forward or back movements appear to include a swagger (gait or manner in moving) to the robots.

The balancing algorithm can receive wireless control inputs for movement. The user can control both wheels independently, allowing for variable directions and turning.

The balance algorithm should also account for changes in center of gravity (CG) due to punching. This CG offset needs to take the position of both arms into account. Even if the arm motors do not have position encoders, the position can be estimated based on when punches are initiated, and the length of time the punch takes to occur. This Arm Position Estimation 650 is feed to the balance algorithm and may additionally need to account for the angular rotation caused by the arm's motion.

Articulated arms 144,145 rest in a position constrained by a hard, mechanical stop. The relatively invariant physical parameters of articulated arms 144,145 and their known resting position make it possible to predict their position during actuation. The extension of articulated arms 144, 145 during actuation cause a change in the center of balance of robot 100 given by a predetermined function of the actuator arm 144, 145 position. Arm Position Estimator 650 calculates the change in center of balance during the duration of a punch actuation of articulated arms 144, 145 and creates balance adjustment signal 660. Balance adjustment signal 660 is input into balance controller algorithm 600 whereupon it uses the information of balance signal 660 to anticipate and compensate for the motion of actuator arms 144, 145.

Additionally, the extension of articulated arms 144, 145 imparts an angular momentum impulse into the robot 100 that perturbs robot 100 angle slightly backwards and then slightly forwards. In the present invention, the extension profile of articulated arms 144, 145 is estimated in the time domain. Said extension profile is used to estimate the angle profile in the time domain of robot 100 by virtue of the physical dynamics of articulated arms 144, 145 and robot 100. In the present invention this estimated robot 100 angle profile due to articulated arms 144, 145 extension, and imparted into robot 100 angle profile is subtracted from the measured robot 100 angle so as to prevent an unnecessary reaction in balance controller 600.

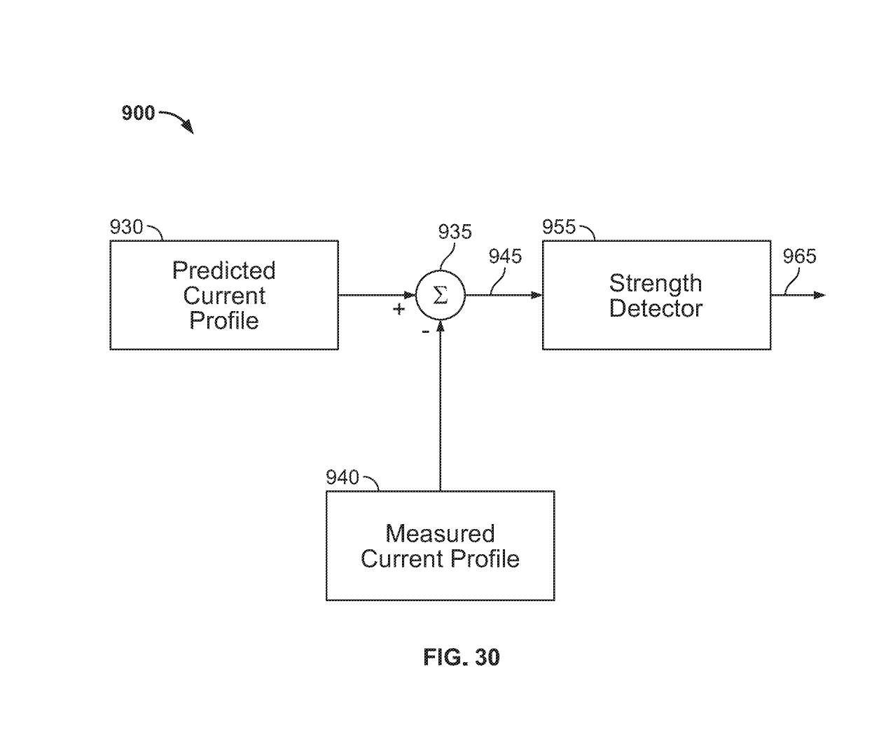

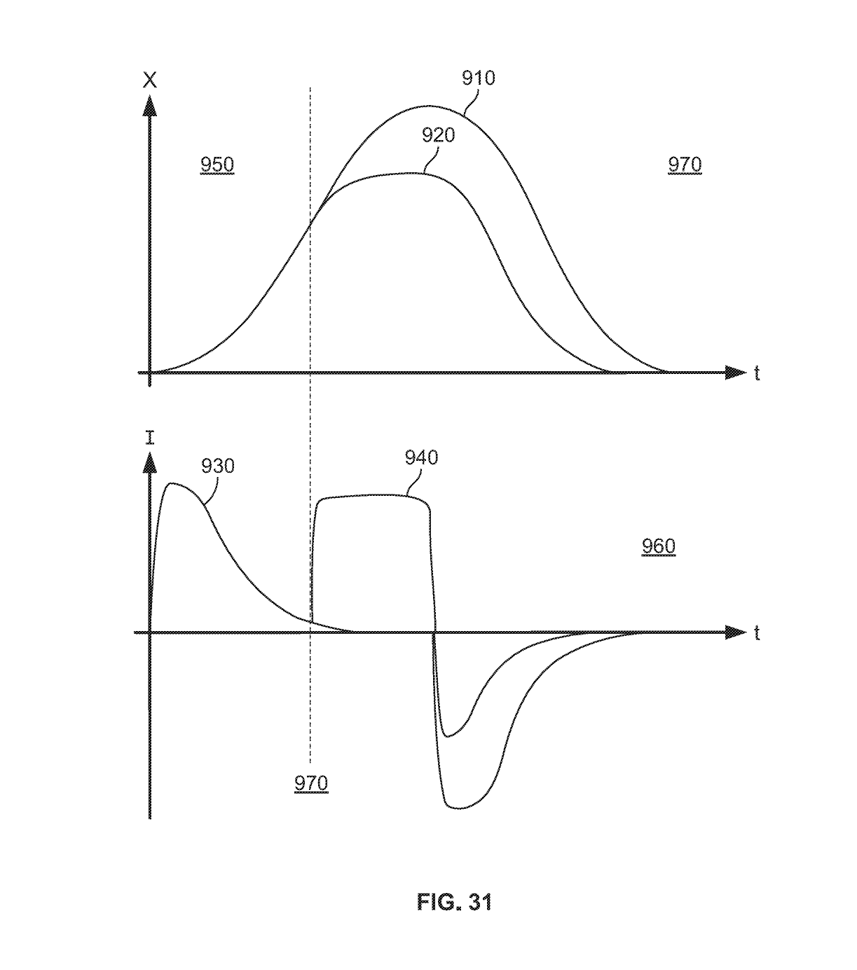

Referring now more closely to FIGS. 30 and 31, the present invention further includes a novel punch detector 900 to detect a landed punch. Whereas an articulated arm 144, 145 follows a predictable extension profile 950 in the time domain as estimated by Arm Position Estimation 650, so does the current in actuator 148, 149 follow a predictable profile 960 in the time domain as measured by divers 250, 260, 270, 280. In the present invention, deviation 940 from the known and/or predictable actuator 148, 149 current profile 930 is subtracted in subtractor 935 to produce punch current difference 945. Punch current difference 945 is used to determine whether a punch has landed and at what point 970 in the extension 920 of articulated arm 144, 145 the punch made contact. Using the punch current difference 945 between the expected actuator 148, 149 current 930 and the measured actuator 148, 149 current 940, an estimate of the strength and duration of the punch is formed using methods familiar to those in the art in strength detector 955, and output on strength signal 965. Typical curves corresponding to the various blocks are shown versus time, where the same labels are used to correlate the blocks 930, 940 with the waveforms they encounter.

The present invention further includes compensation for a landed punch. Certain predetermined punch sequences that may be initiated by the user may compensate for an expected landed punch. In this case, the expected robot 100 angle profile in the time domain, actuator 148, 149 current profile in the time domain, and predicted balance center profile in the time domain may all include the assumption that the punch lands. Further feedforward wheel drive 630 commands or user motion commands 640 may be included to help deliver greater punch force to the target. In this case, if the punch does not land as anticipated, robot 100 may stumble similar to how a human boxer would stumble when missing a punch.

Referring now to FIG. 6, the present invention further includes feedforward punch compensation employing arm position estimator 650 to maintain more stable operation under punching. There are several factors to the method of the present invention. Firstly, without compensation, when the arms extend, they shift the robot center of mass. This causes the robot to move forwards while the rebalancing loop compensates. In the present invention, the position of the fists is estimated as the expected position of the fist as a function of time (for example the curve of 910) for each predetermined punch profile. Thus, for each thrown punch, the change in the angle of the center of mass is a predetermined function of time and is added to the balance loop angle set point (feed-forward) so as to prevent the robot from attempting to re-adjust the angle offset. Secondly, torque stimulus is imparted on the center of mass along the balance axis during a punch. This causes the robot balance angle measurement to jut forward and then backward as the fist accelerates and then decelerates. However, since this profile of motion is predetermined, a compensating signal of equal and opposite polarity is injected from the gyro signal. This prevents a perturbative impulse from traveling through the control loop resulting in an unwanted oscillatory response. Thirdly, on occasion a punch will land, and the amount of disturbance imparted on the center of mass will differ from a predetermined disturbance profile of an unimpeded punch. In this case, the drive current to the motor is monitored and compared against a predetermined current profile for unimpeded punches. As the punch lands harder, the measured current reflects this difference. Thus, the difference between the measured current profile and the unimpeded current profile is used to stimulate the control loop in such a way as to cause the robot to behave in a more stable manner. Fourth, certain predetermined punch sequences may involve predetermined compensation in anticipation of a hard-landed punch. In this case, the robot may lurch forward and even lose balance if the punch does not land as anticipated. This mimics the same gamble a boxer may take when trying to land a knockout punch.

Continuing to refer to FIG. 6, damage detector 700 employs predictive observer 770 to estimate the state and inertial measurements of robot 100 using the known dynamics of robot 100, user motion commands 640, balance adjustment signal 660, motor state estimation 725, and inertial measurements 720. Motor state estimation 725 is provided by motor state estimator 655. Inertial measurements 720 can include but are not limited to gyro rate measurements and accelerometer measurements. Inertial measurements are provided by inertial sensor 710. Predictive observer 770 uses this information to determine the robot 100 next-state, which is communicated by next state output 730 to delay element 780 and then brought to summer 750. Kinematic state estimator 740 uses inertial measurements 720 to independently estimate robot 100 state by kinematic means. The kinematic state estimate is subtracted from next state output 730 by summer 750 to provide differential state and inertial measurement output 760. Event discriminator 790 uses differential state and inertial measurement output 760 to determine the nature and strength of events. Note that differential state and inertial measurement output 760 is, but is not limited to, a vector comprised of a plurality of state variables and inertial measurements. Some events can be easily discriminated using a simple peak detector on a few elements of differential state and inertial measurement output 760. Other events can be determined using artificial neural network algorithms to detect event patterns.

A damage detection algorithm operates along with the balance algorithm, monitoring for large signals on damage event output 795. The damage detector 700 is used to detect when the robot has been punched. The magnitude of damage event output 795 determines whether a large or small punch was detected. The accumulation of damage event output 795 signals is used to determine appropriate changes in the robot's behavior to simulate various degrees of performance degradation in the eyes of the operator.

The damage behavior algorithm is used to make the robot look like it is getting weaker. As the levels of damage escalate, various behaviors are changed. The balance algorithm is made less stable by modification of loop variables, adding more deviation to the balance. The robot can start to have delays in response to user inputs, mimicking sluggish behavior. These delays need to be longer than 125 milliseconds so the user notices the reaction is slowed. When the total damage reached a maximum level, the robot can the programmed to take a fall.

The present invention includes a novel control loop which includes new means of achieving certain responses designed to enhance play-value. In general terms, the control loop provides some features of the prior art, namely a nested loop architecture that provides for balancing, re-balancing to new loads, and velocity control. However, the novel features of the present invention further include dynamic control of the inner-loop (balance loop) compensator parameters and further include direct perturbation of the angle set-point. In this way, realistic action is exhibited in the form of unsure footing (wobbling and almost falling over), and reaction stimulus that mimics external perturbations of various types. Further, additive velocity perturbations are applied to cause staggering or stepping (these inputs are not shown explicitly in the diagram, but come in through the normal velocity commands as additive inputs). With these three novel control mechanisms, realistic boxer behavior is simulated.

Taking hits without falling is important to simulating boxing. This involves a balance of regulating the amount of force in a robot's punch, and the amount of disturbance the balance algorithm and the robot's dynamics can withstand. The goal is a robot that will not fall over at the slightest punch. The delicate balance of taking punches but falling sometimes is not reasonable to achieve in a functional design. The better method is to create a robot that cannot be easily knocked down by a similar robot, then intentionally creating a fall when enough damage is taken. The programmer then has control to determine the approximate length of matches. The programmer can also control the amount of randomness in the match before the end. Making the play pattern match the attention span of kids is important in toy design. Having control over how fast a fight will end or preventing the fight from ending too soon or taking too long is key to keeping kids attention.

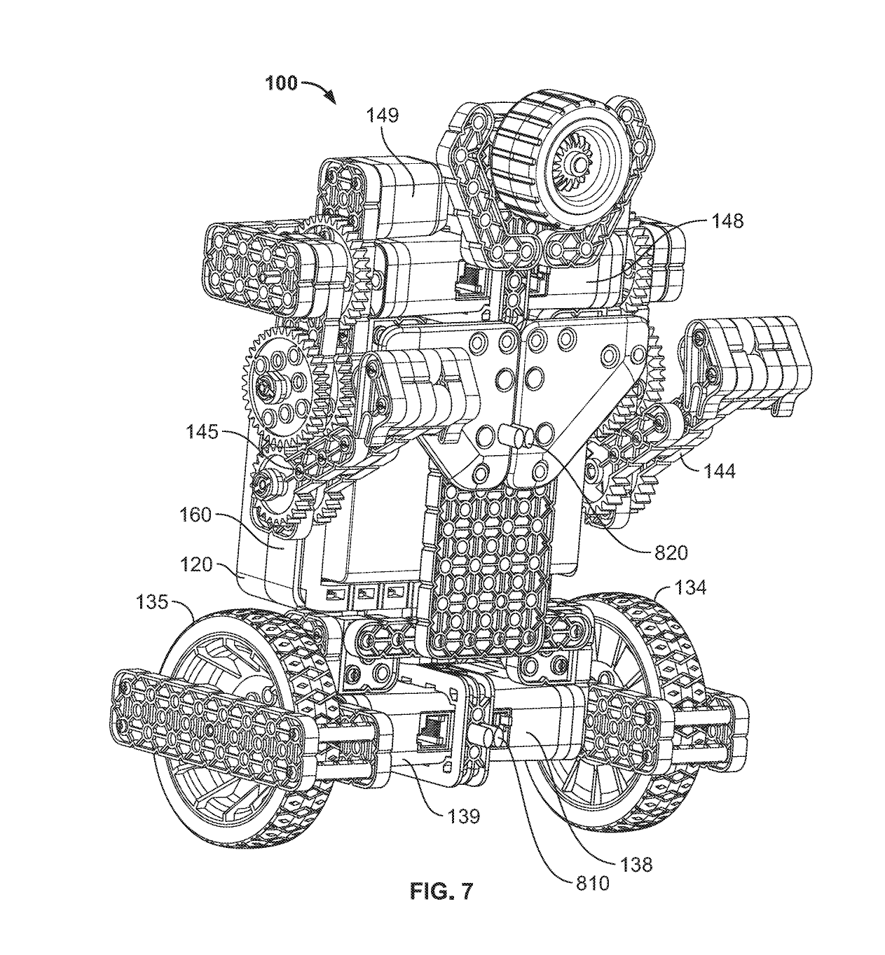

Referring now to FIG. 7, in another embodiment a high forward-looking proximity sensor 820 or a low forward-looking proximity sensor 810, or both a high forward-looking proximity sensor 820 and a low forward-looking proximity sensor 810 are mounted on the front of robot 100 to detect the presence of another object. This allows the user motion commands 640 to be overridden if the user attempts to push their robot 100 into another robot or an immovable object. Normally the user motion control 640 and the estimated robot 100 state are subtracted to derive an error signal and said error signal causes a compensator to increase internal error integrators into a state that would most likely result in robot 100 toppling after said obstacle is removed. In this embodiment, information from the forward-looking proximity sensors 810, 820 is used to limit the user motion commands 640 to a robot 100 state for which robot 100 can recover without falling when the obstacle is removed.

This is particularly helpful when two balancing robots are commanded to push on each other. In such a case, without proximity detection and overriding the control inputs, the most likely outcome would be loss of control and toppling of both robots.

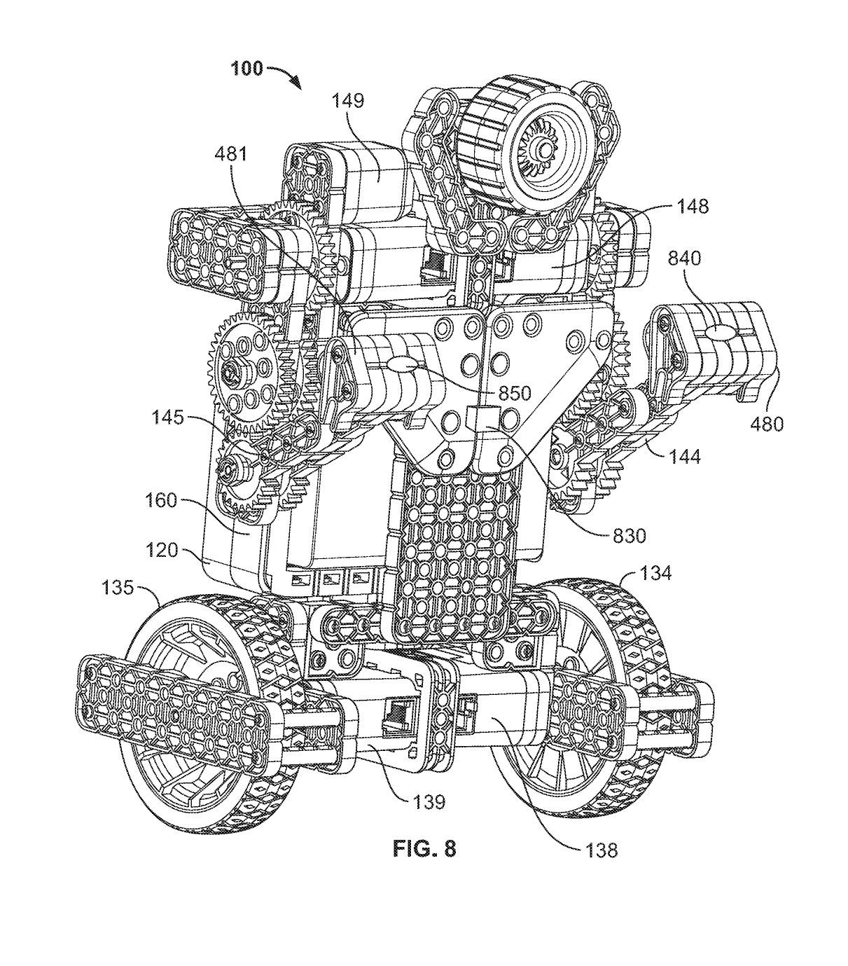

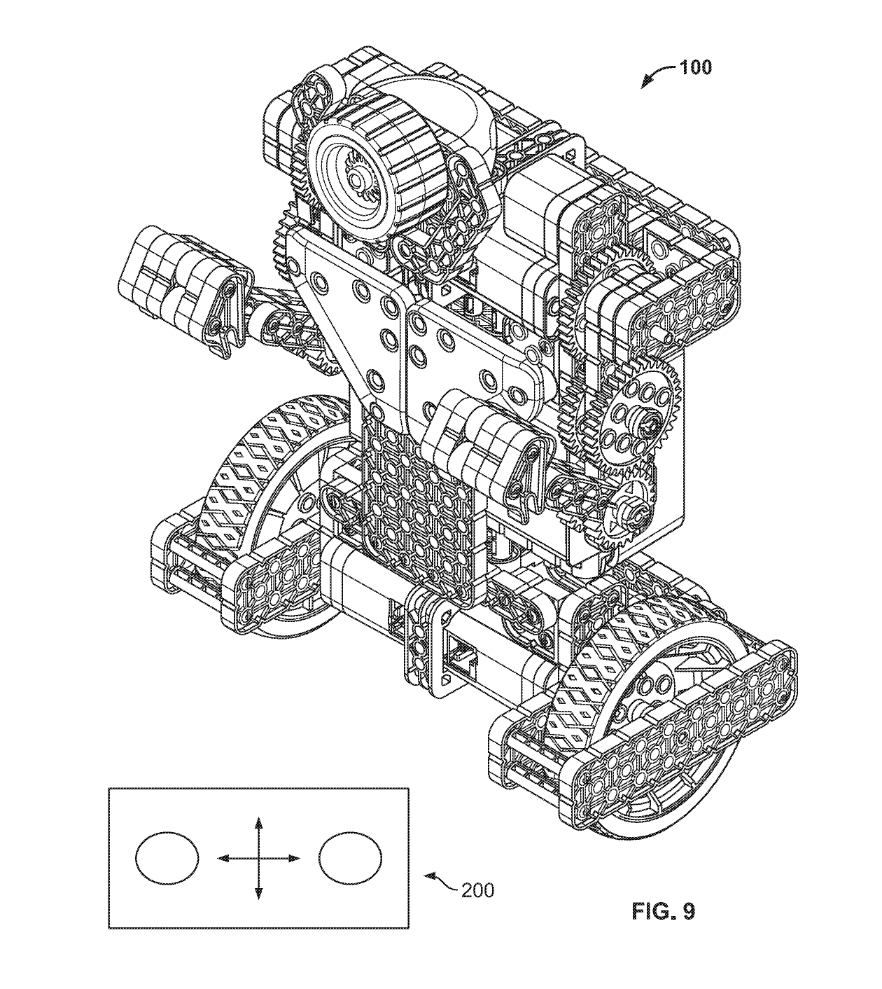

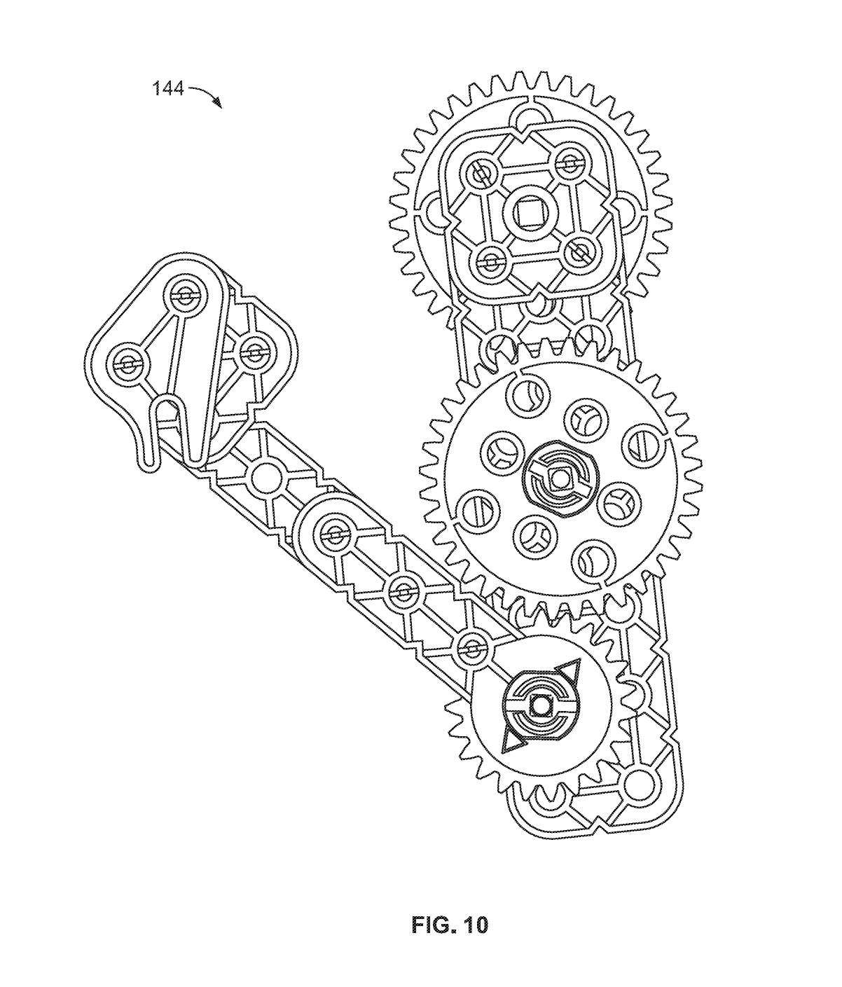

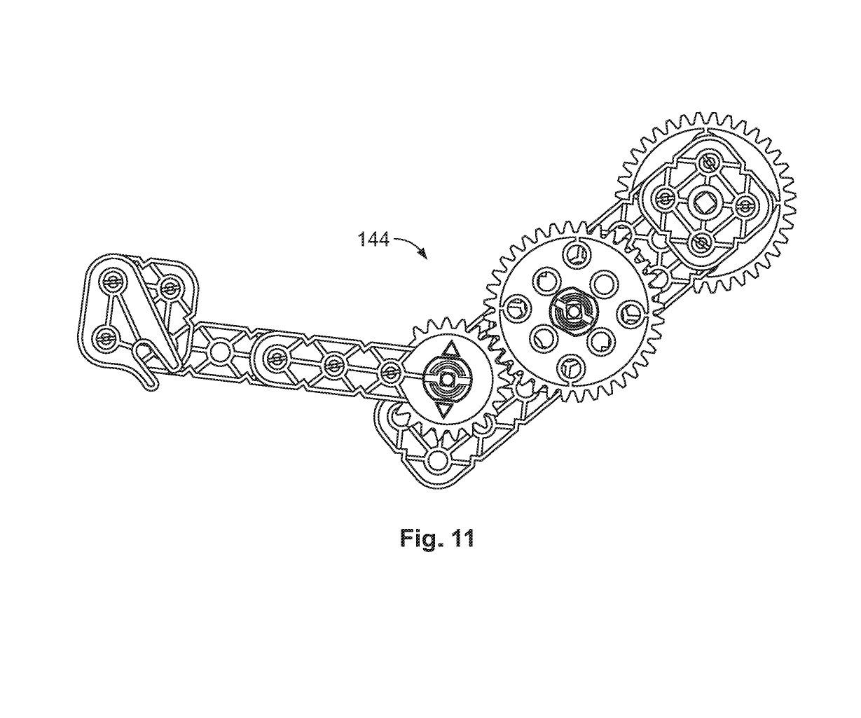

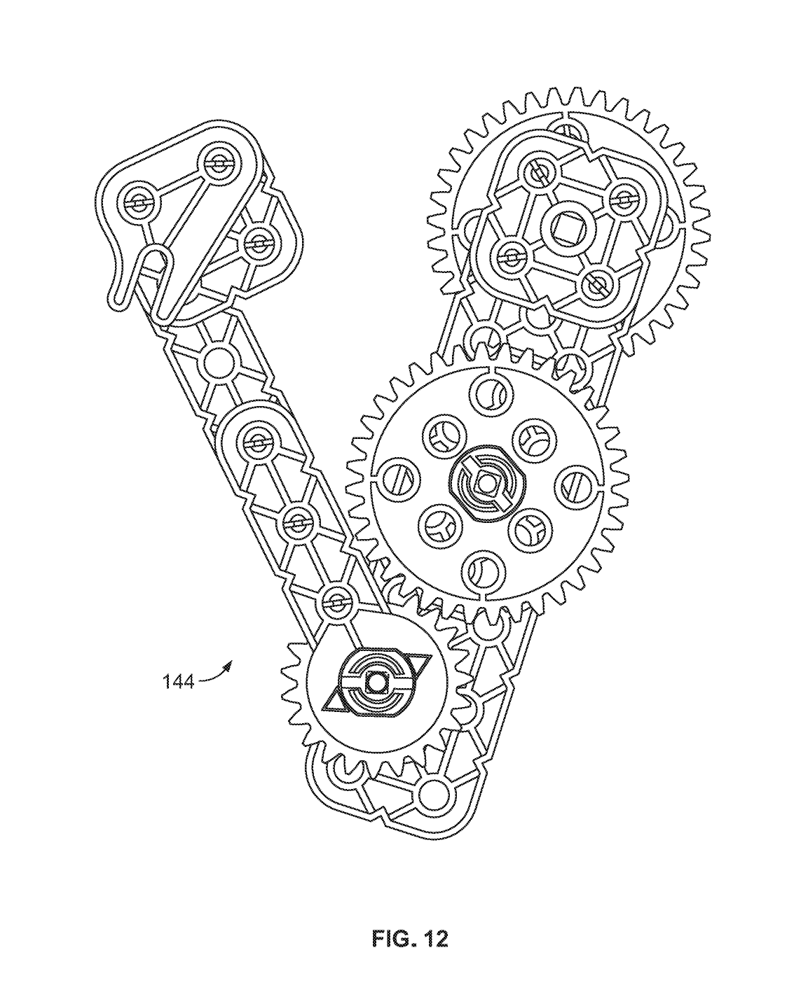

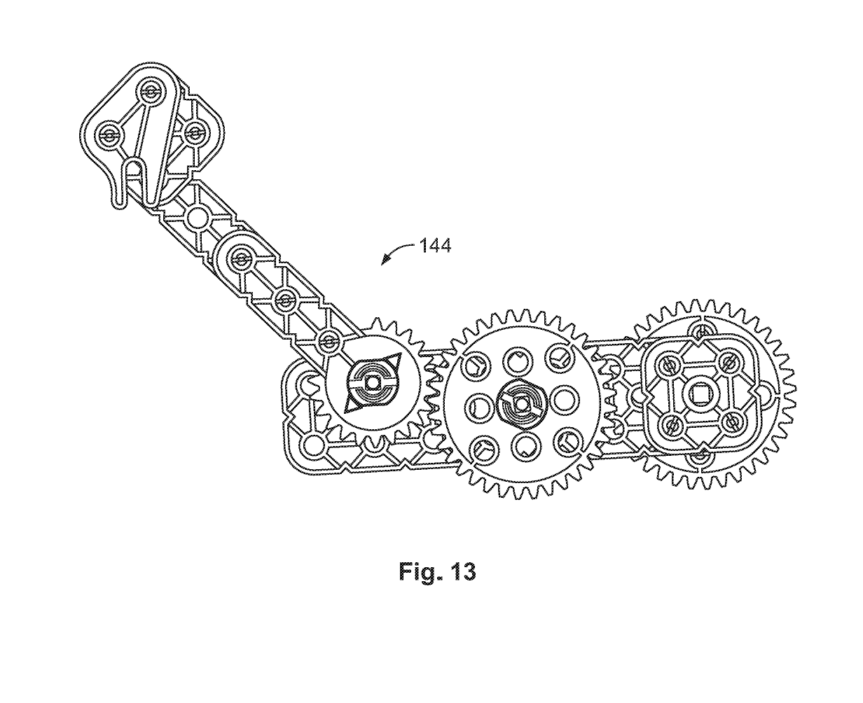

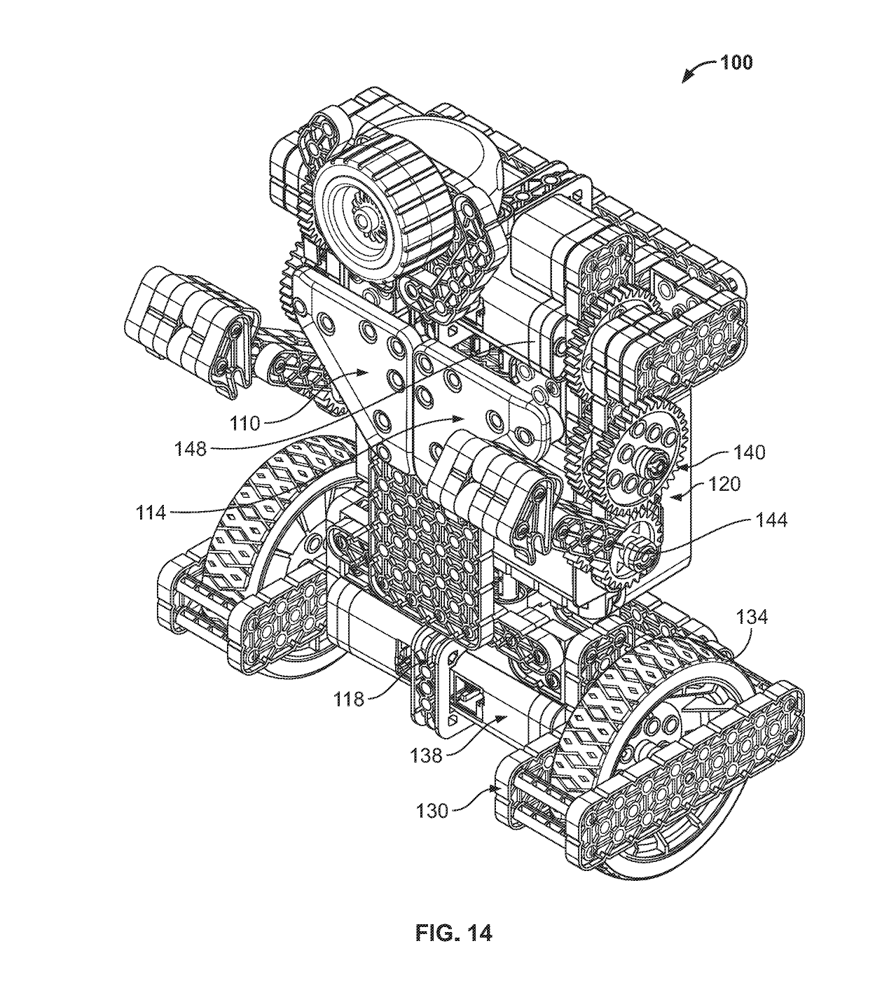

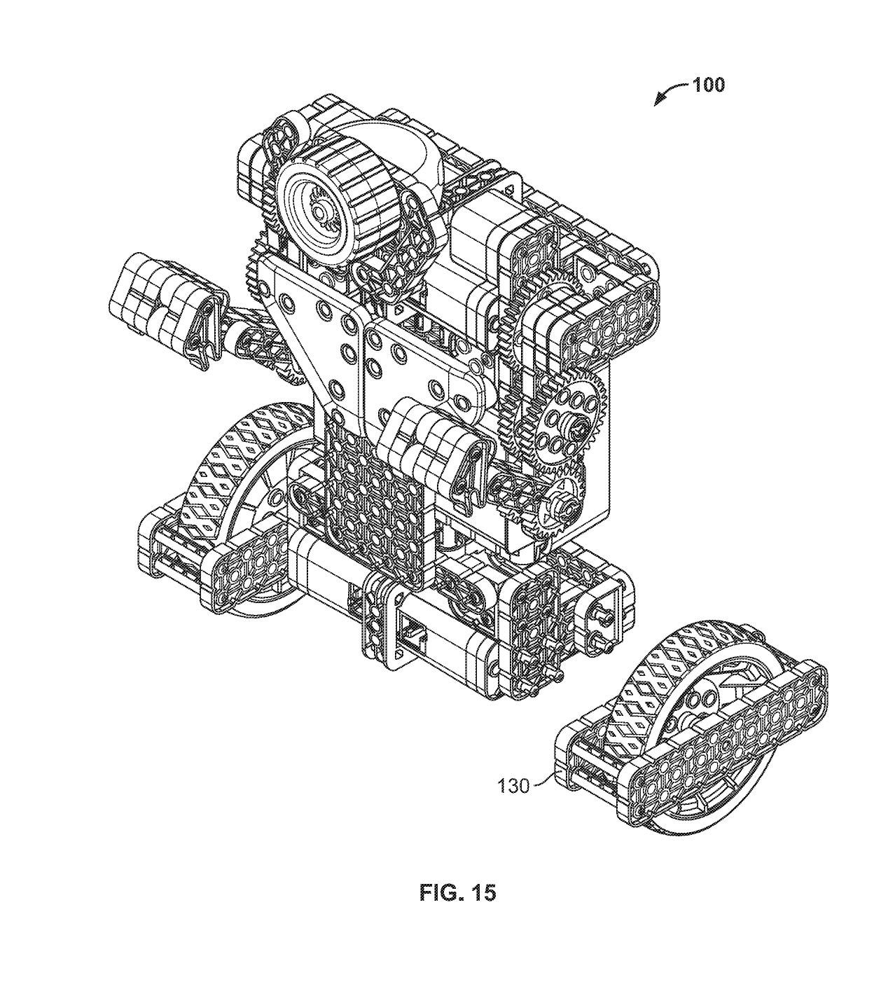

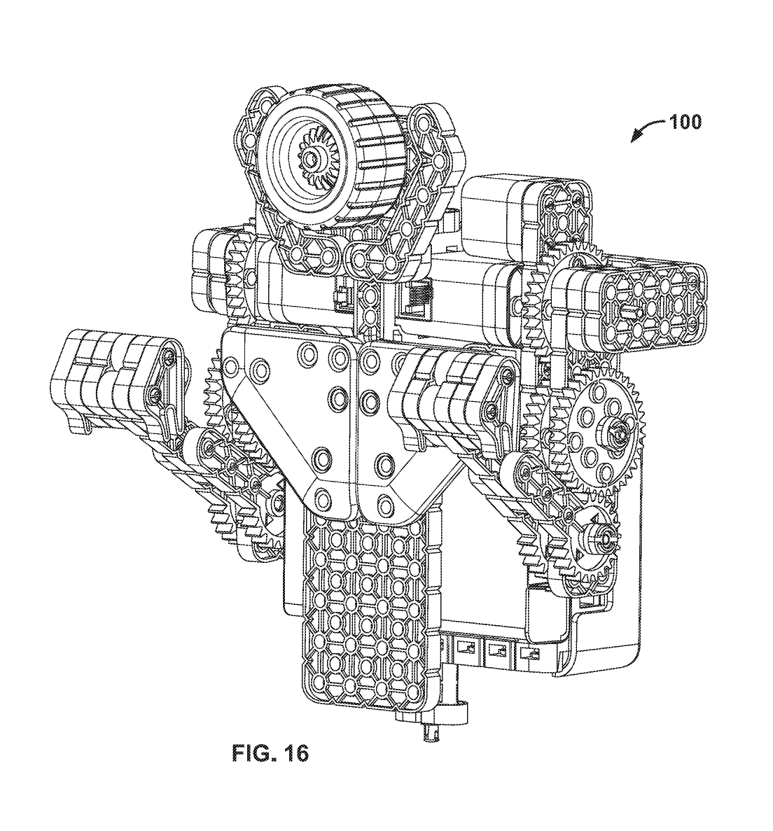

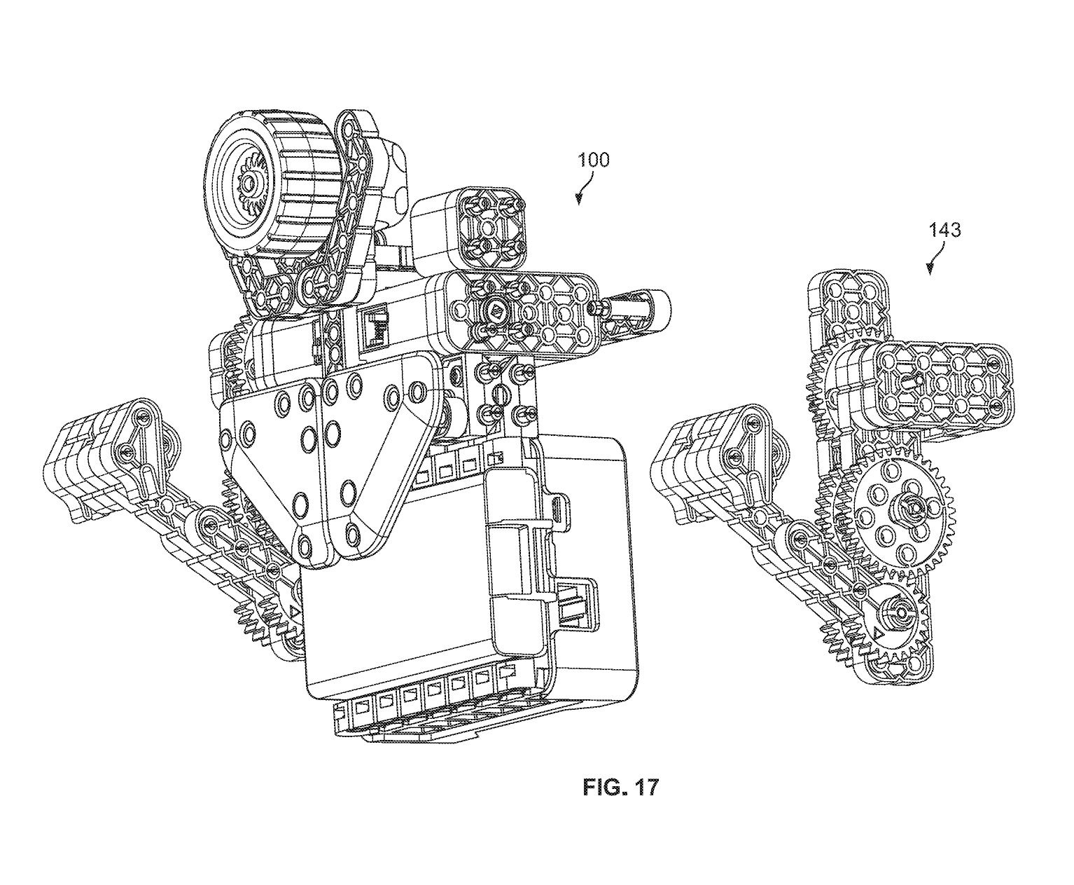

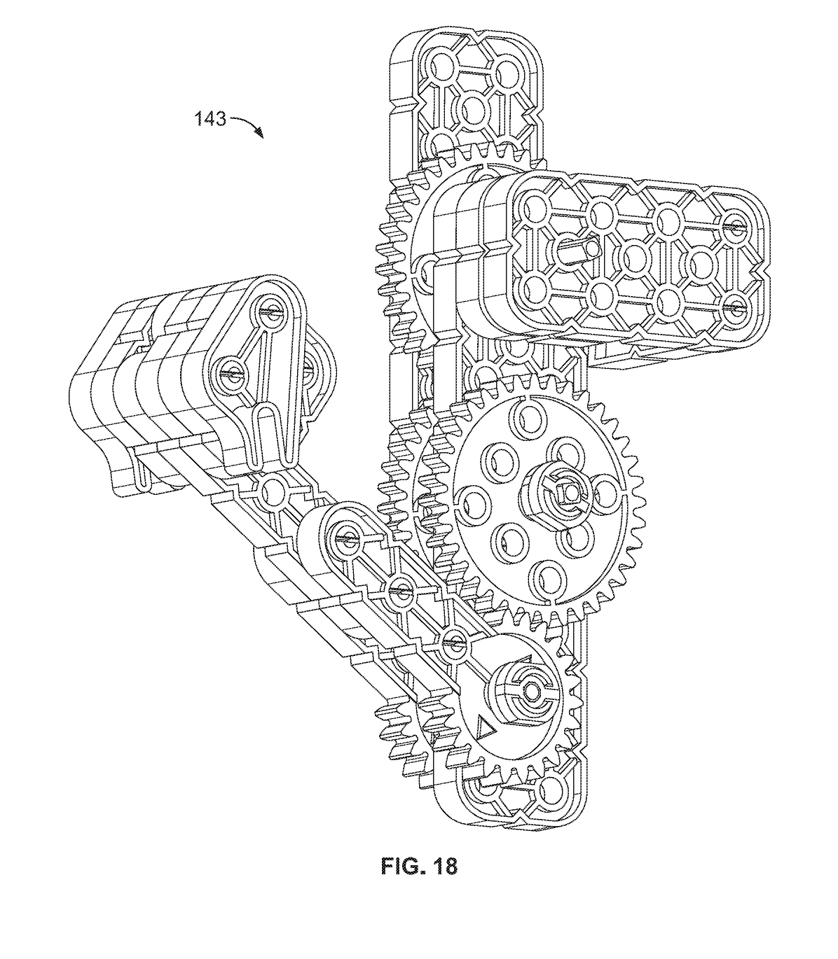

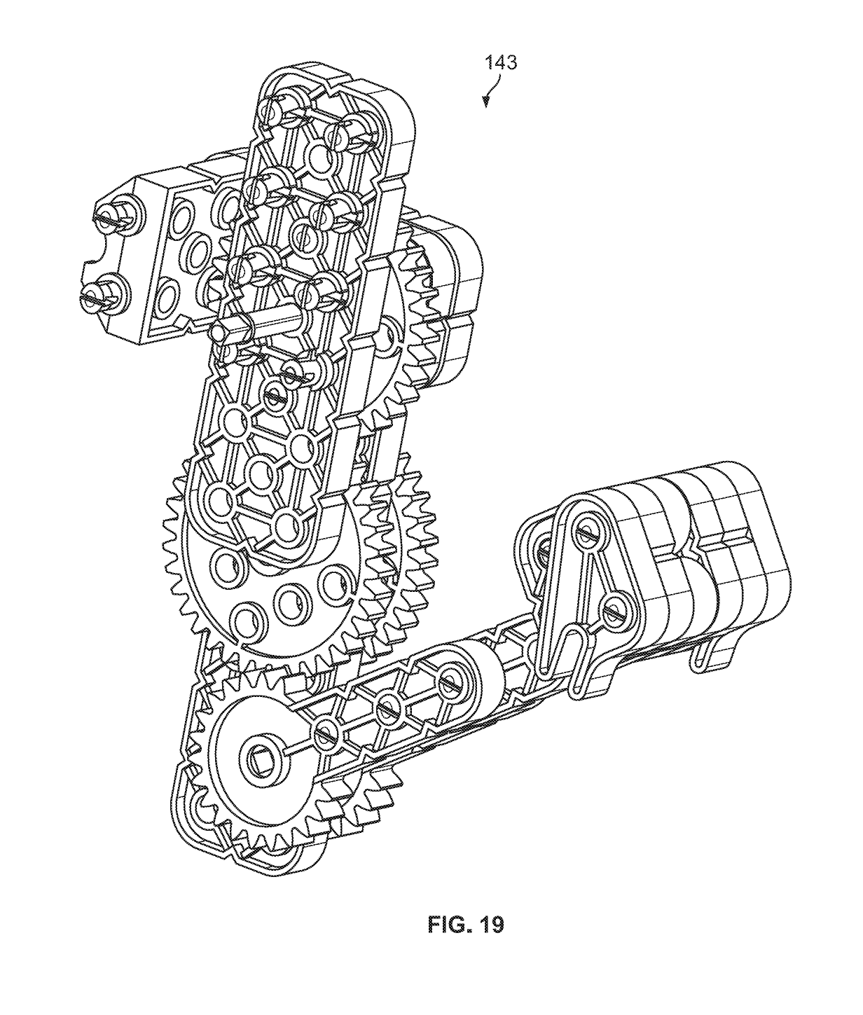

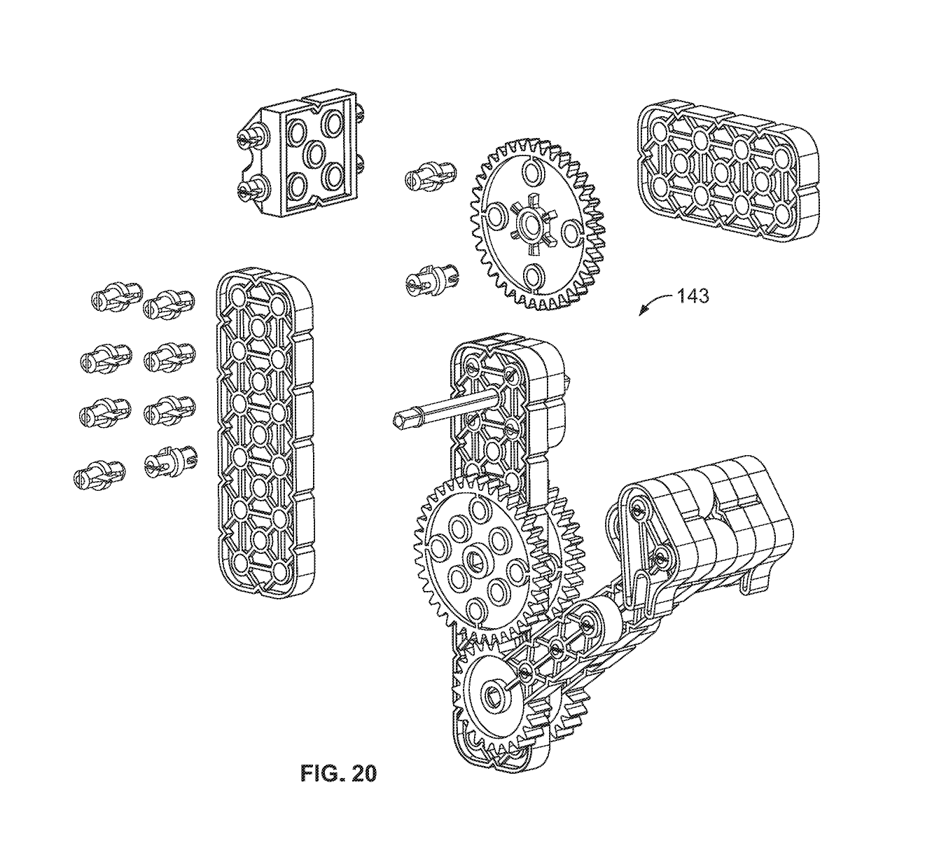

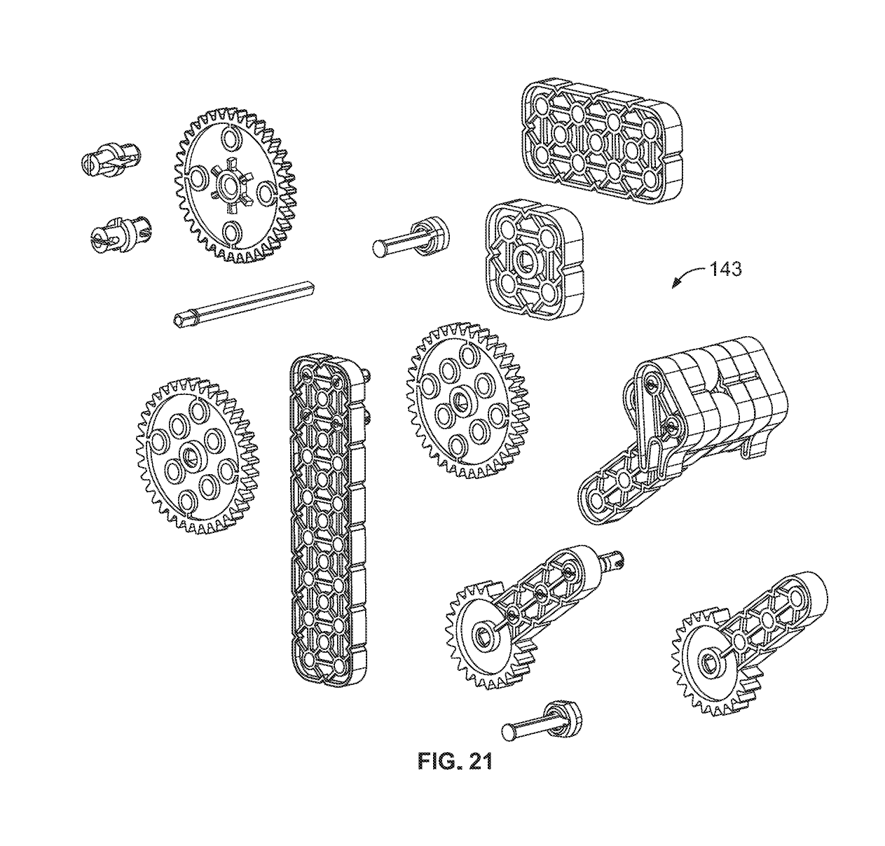

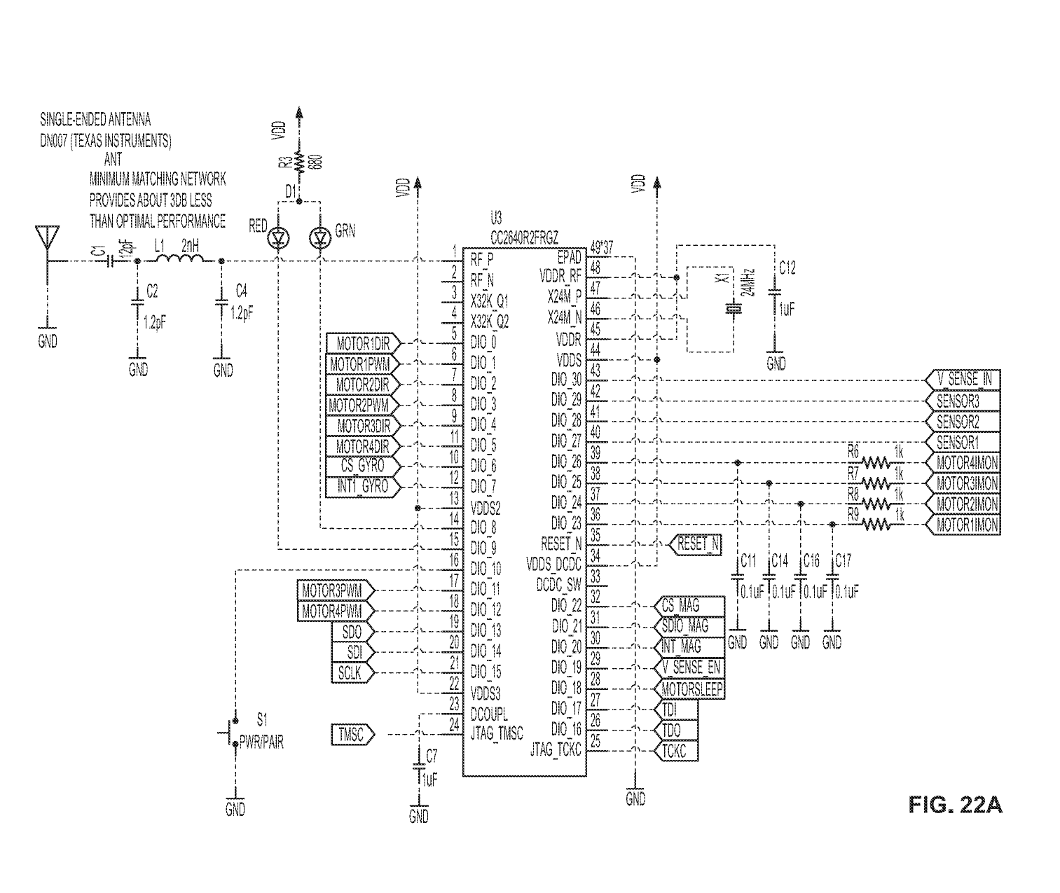

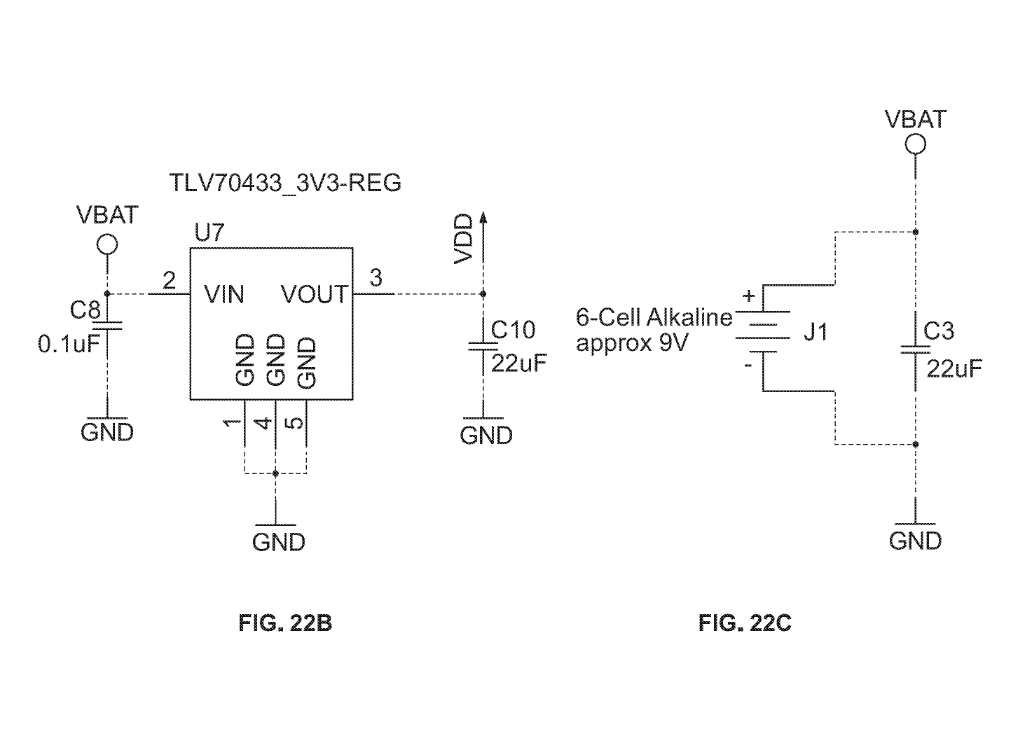

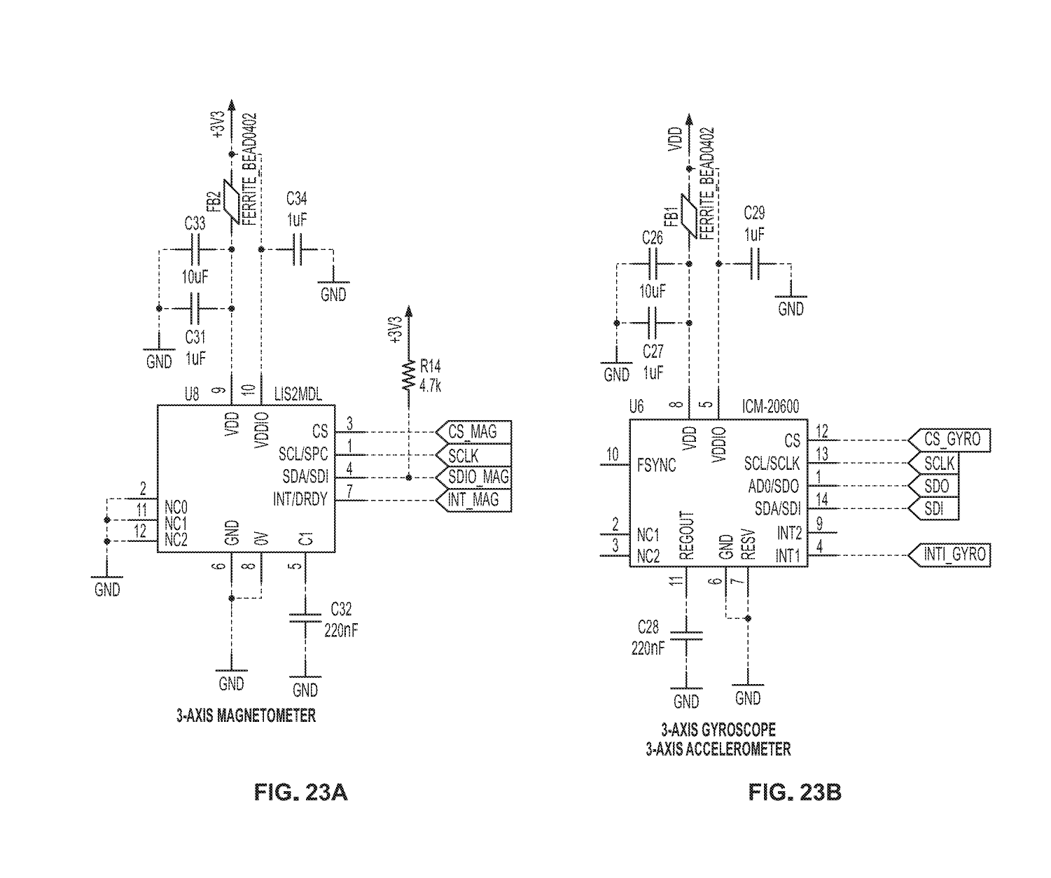

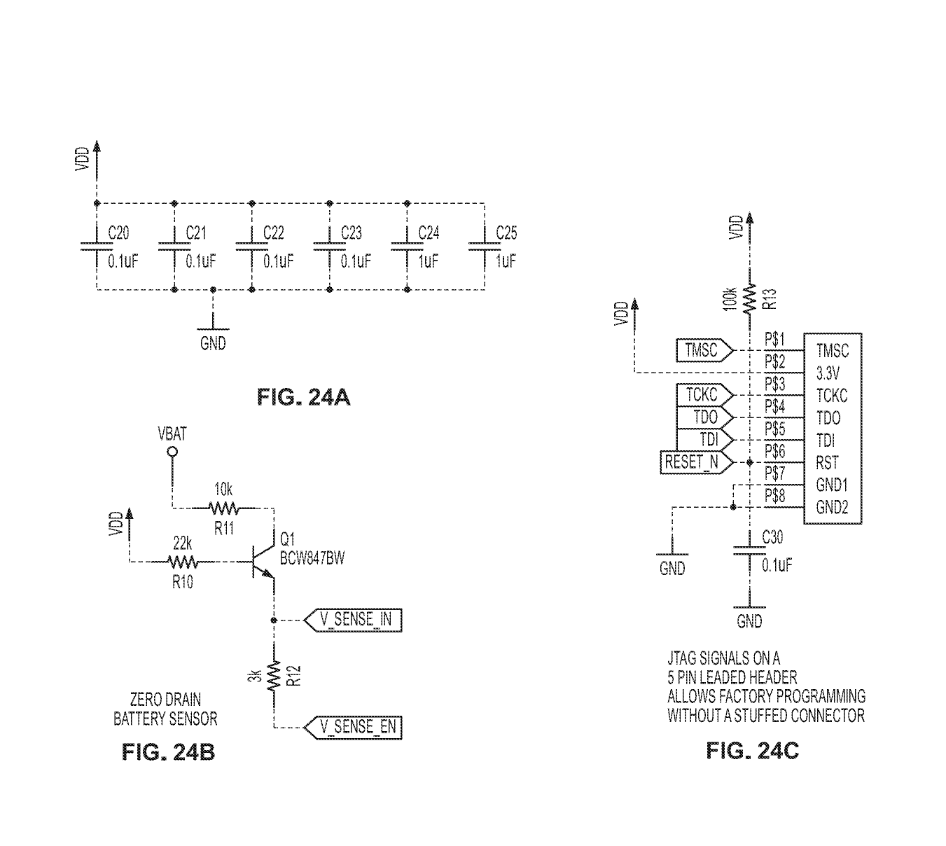

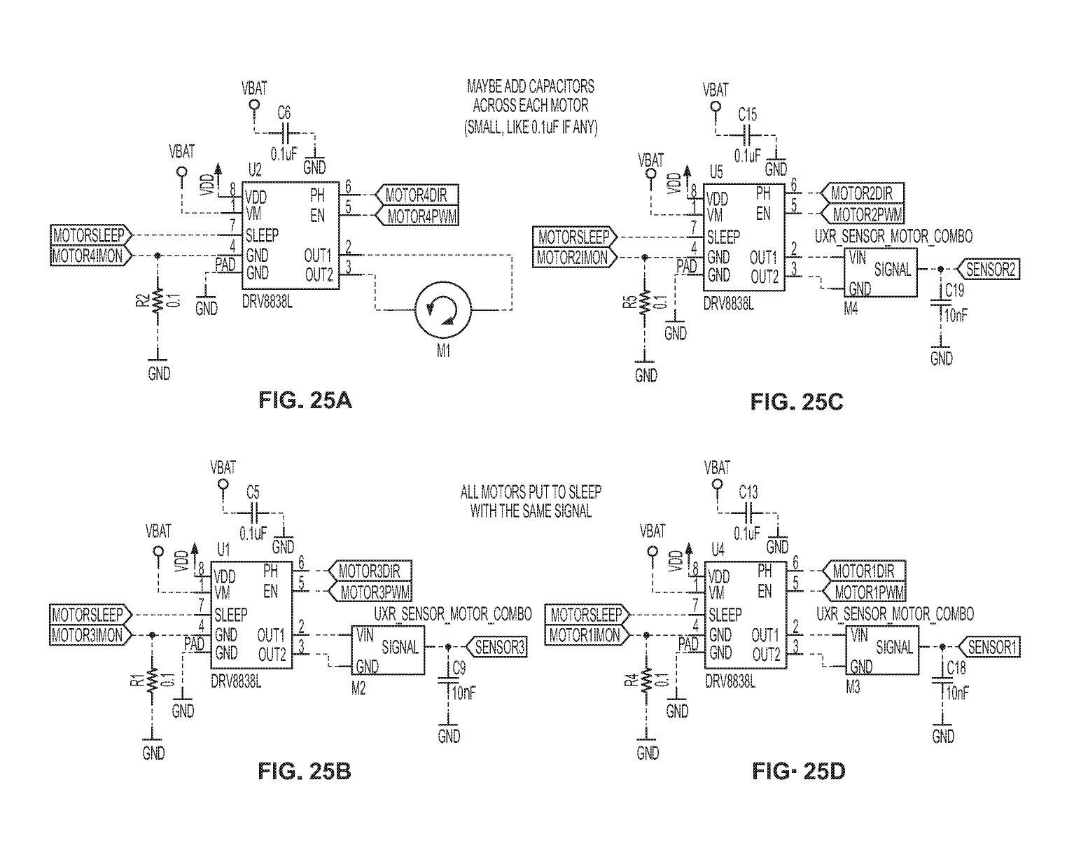

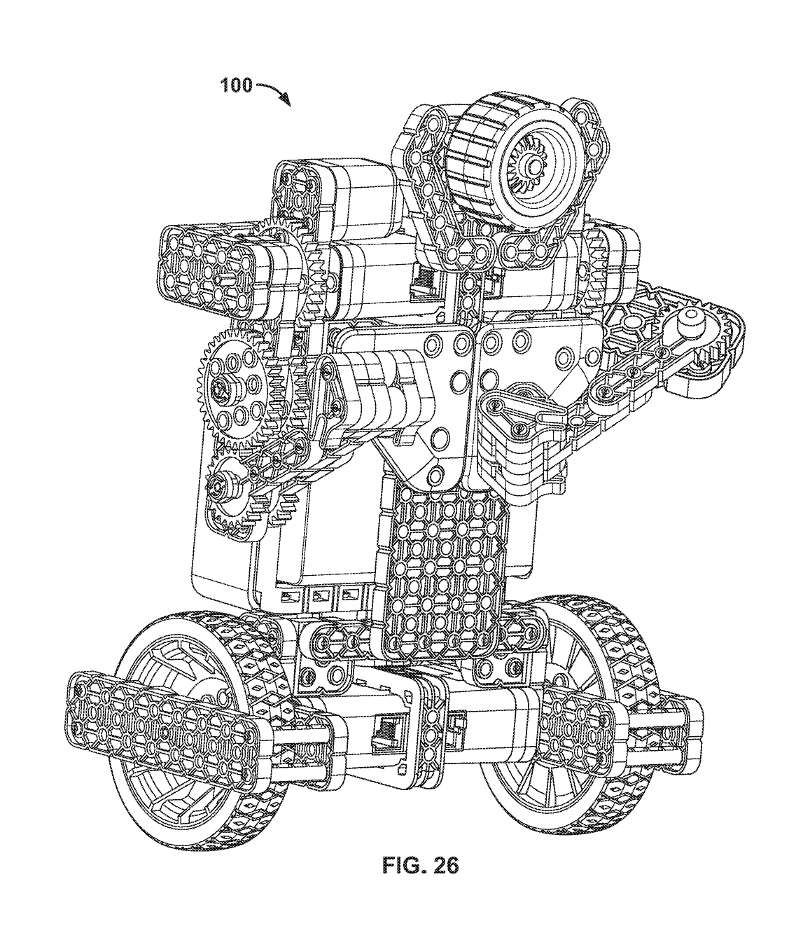

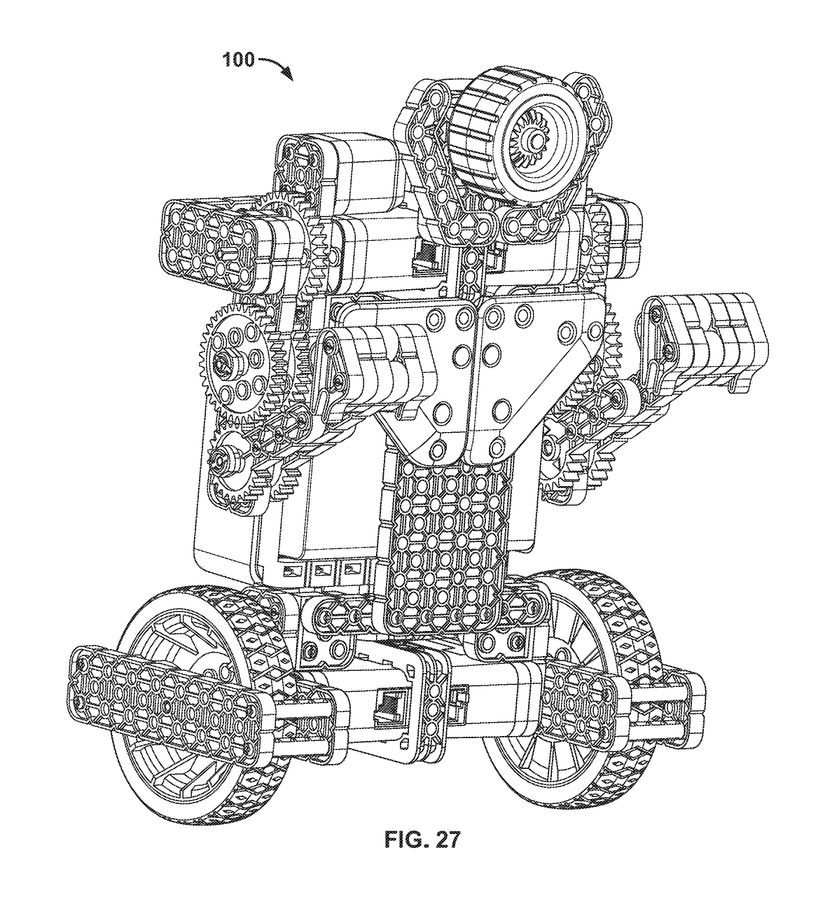

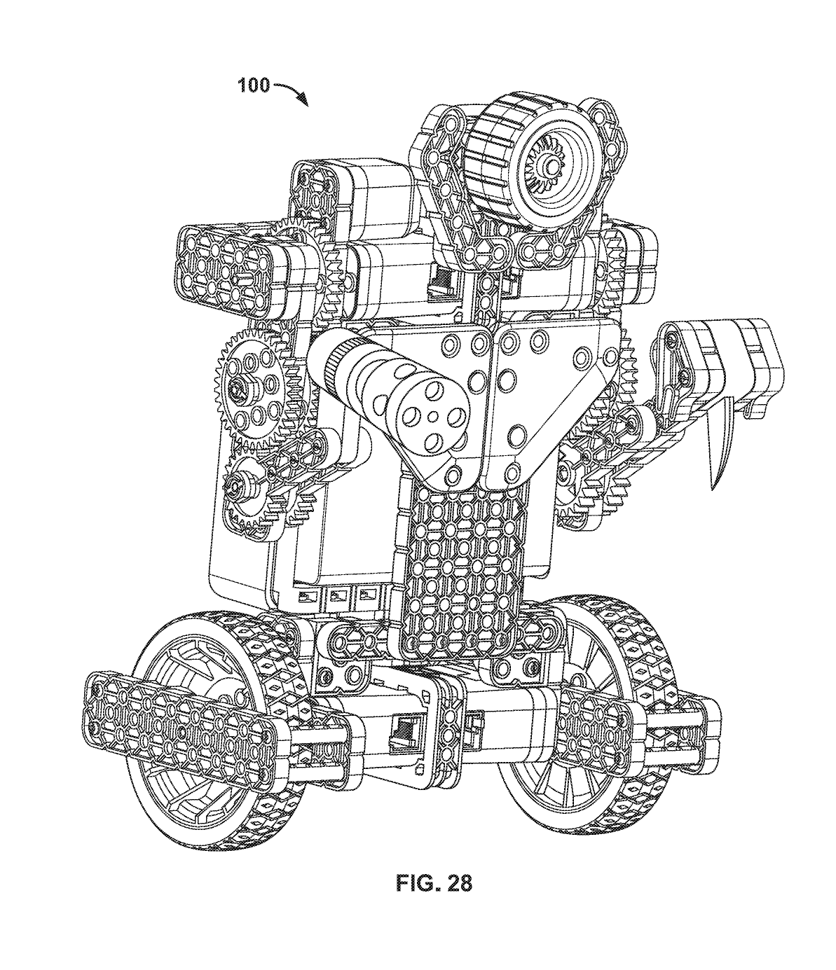

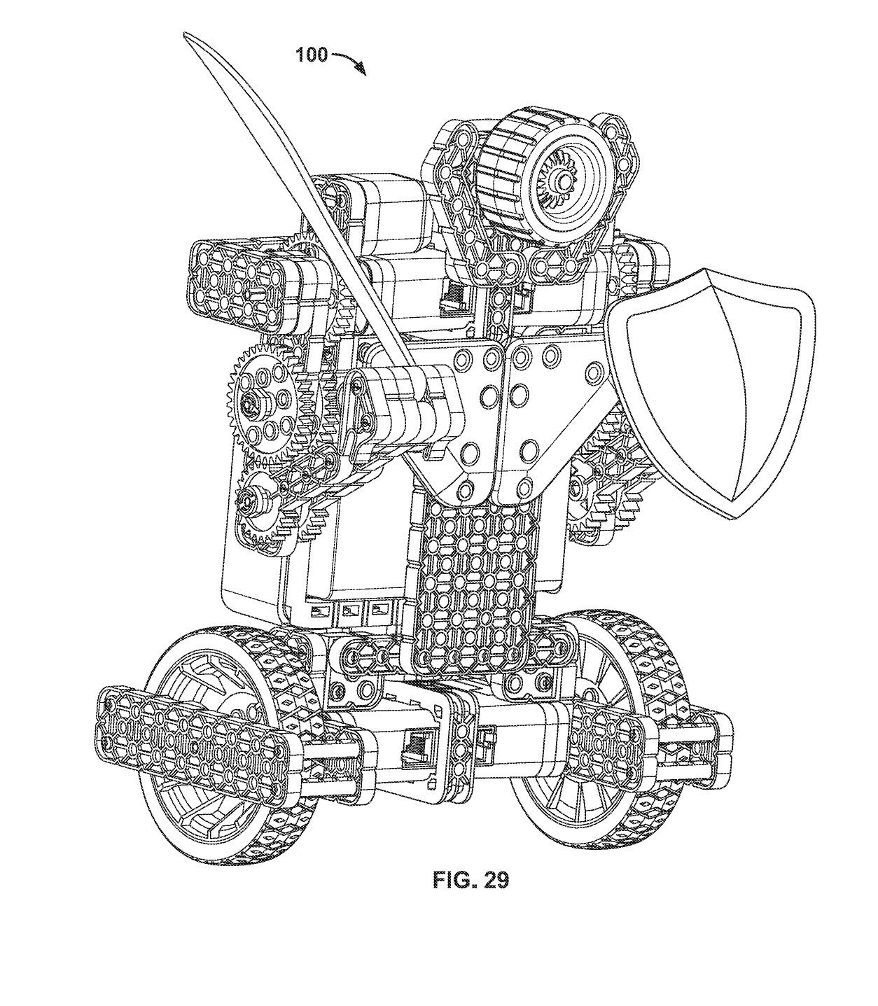

In an alternative embodiment, illustrated in FIG. 8, the proximity detection can be performed using magnetometer 830 and left fist-mounted magnet 840 and right fist-mounted magnet 850. Thus when fists 480, 481 of an opposing robot is detected by magnetometer 830, the command input of the user can be overridden so as to prevent the loss of balance.

Said chest-mounted magnetometer 830 is further used, in conjunction with magnets 840, 850 in the robot 100 fists 480, 481, to detect direct hits as well as weak hits and near misses. In this embodiment, the fist-mounted magnets 480, 481 are polarized so that North points forward, away from fists 480, 481. As such, the chest-mounted magnetometer 830 can detect not only the distance of the punches, but whether they came from the front or from behind.

In an alternative embodiment, the magnets 840, 850 in the robot fists 480, 481 respectively are arranged as North-forward for left magnet 840 in left fist 480, and South-forward for right magnet 850 in right fist 481, to provide left versus right punching information to on-board processor 120. This information (as provided in either embodiment) can be used to program appropriate responses to the punch. For example, if magnetometer 830 on a robot 100 determines it was hit with a left punch, and said robot 100 has just been commanded to throw a right punch, it can turn left as it throws the punch (as a real boxer would do) to better hit the opposing robot 100, rather than throw a punch into the air.

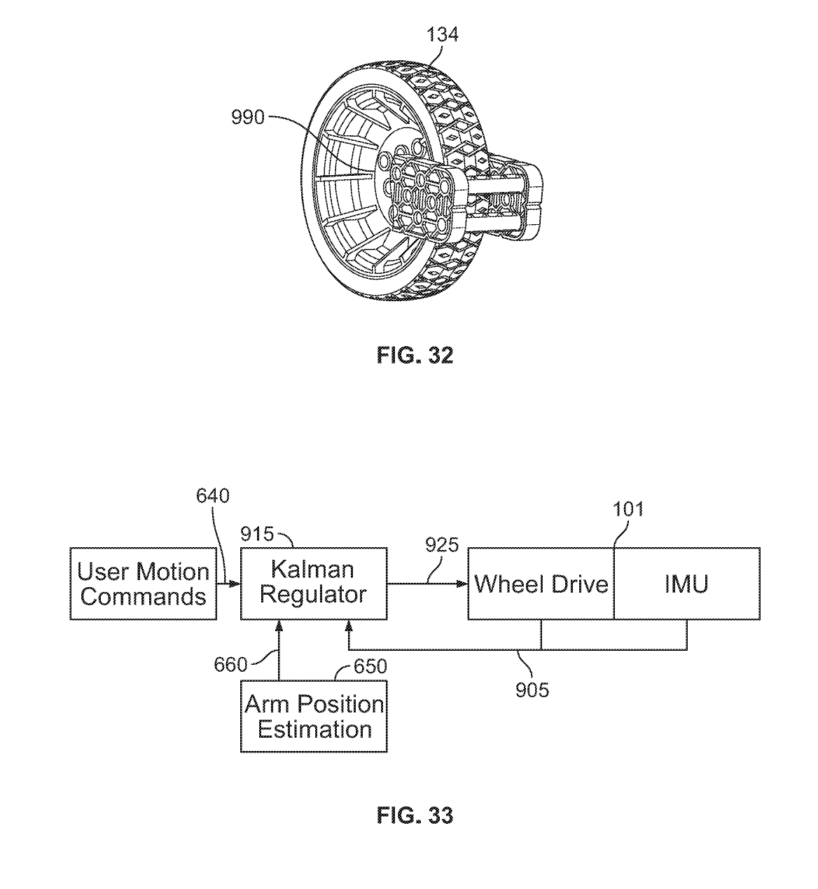

Referring now also to FIG. 32, position encoders 990 are used on the wheels to improve the accuracy of control, detect obstacles, and recover from external perturbations. This is known as odometry. In usual balancing systems, odometry is used to improve the control loop to provide the most stable system. In the specialized system of the present invention, many perturbations are anticipated, including complete obstruction, and even being forced in the opposite direction as the command input. Here, odometry is employed as not simply a feedback state, but as a sensor whose input is fed into high-level decision making logic in the on-board computer 120. The object of the odometry in the present invention is to serve as additional sensory input allowing high-level decision algorithms to determine and classify various types of external input stimulus.

As a further feature of the present odometry invention, motions of the wheels can be used to sense input gestures from the user, for example a rapid swipe forward may indicate various operational modes. As a further feature of the invention, the odometry data is also be used as input to the control loop to improve the response as is sometimes done in the prior art.

In an alternative embodiment, position (odometry) encoders are avoided by the use of inertial measurements. In this embodiment, precise turning is obtained by numerical integration of a gyroscopic rate about the substantially vertical axis. Thus, for example, a precise and rapid 90 degree rotation can be executed as part of a dancing algorithm.

It is common in the prior art to use a PID (Proportional, Integral, Differential) controller. In the preferred embodiment, an EKF (Extended Kalman Filter, FIG. 33) regulator 915 is used so as to provide at least two features of the present invention. One feature is to provide improved control loop performance given the optimal state estimation afforded by the EKF regulator 915 approach. A further feature of the present invention is to use the known and expected state of the robot as predictive observer 770 in order to further classify the external stimulus. Thus, the present invention employs the state difference 760 between the measured state versus the predicted state based on the unperturbed equations of motion. The state difference 770 amounts to a differential state vector that provides a wealth of information by which the external stimulus can be classified. For example, if an offset punch is landed on the robot from an opponent, a slight angular spin may be imparted as well as a thrusting back of the torso. This nuanced response can be used to distinguish such a punch from a head-on punch that does not impart angular spin.

In the present invention, a punch classifier technique and algorithm is employed operating from the full differential state vector as well as full inertial sensor inputs from the on-board sensors. The inertial sensors include additional axis of gyroscope, accelerometer, and magnetometer. The differential state vector contains the full robot state allowing the punch to be accurately detected and classified. In the case of the example of the last paragraph, the information in the differential state vector, would allow it to be distinguished as an offset punch. The accuracy with which the punches are detected and classified directly correlates to the realism of play. This is because a few well landed punches should have more impact on a health metric, than several poorly landed punches. The present invention employs a classification algorithm that takes as input the full differential state vector in order to accurately detect and classify punches.

A unique shut-down algorithm of this invention is used to determine when the robot should transition from an active balancing state to an idle state. In the active balance state, the motors are driven to compensate for any tendency for the robot to tip over, as well as to reflect the desired driving and punching commands of the user. In contrast, the idle state is one in which the motors are not driven, nor are punches thrown in response to user input. It is desirable to transition to an idle state when the robot falls down or is stowed so that the motors do not cause erratic behavior, noise, and battery drain. The present invention employs an algorithm to determine when the robot is no longer balancing using the differential state vector as well as the inertial sensor inputs. In the preferred embodiment, the inertial sensor inputs are used to determine the full robot attitude with respect to the acceleration of gravity of Earth. Thus the algorithm determines when the robot is in an attitude where it is known to be unable to maintain balance. When such attitudes are measured, for a predetermined amount of time, the robot enters into the idle state. A filter is used to ensure that a plurality of consecutive measurements are averaged such that single anomalous measurement events do not cause the robot to transition to the idle state.

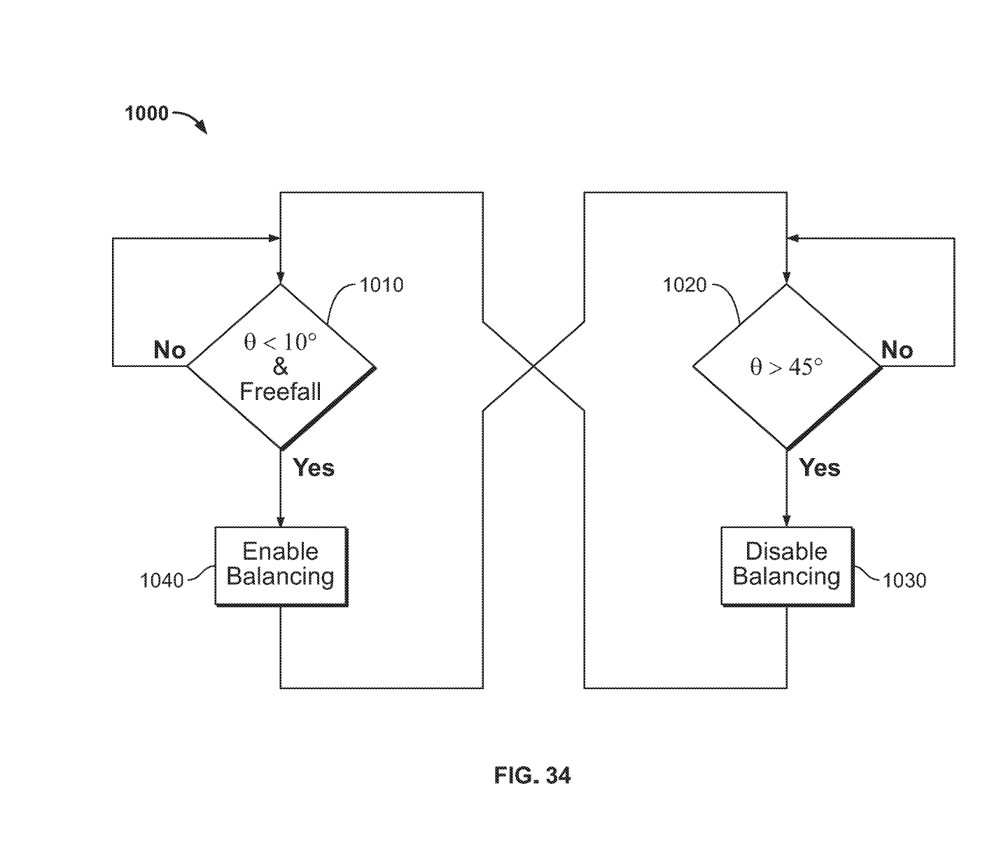

A unique instantiation algorithm 1000, FIGS. 6 and 34, of this invention is used to determine the intention of the operator to instantiate balancing. In the use of any balancing robot, there is a need to determine when the operator desires to cause the robot to transition from an idle state to a balancing state. The instantiation state is determined based on the robot coming near to a vertical position as measured by the attitude algorithm based on the inertial sensors. When an operator positions the robot to the near vertical position, the EKF (Extended Kalman Filter) begins to accurately estimate the state. However, the differential state vector (including inertial measurements) in conjunction with the external stimulus classifier 700 of this invention will detect the external stimulus of the operator's hold upon the robot. When the operator releases the robot, the external stimulus classifier 700, using the differential state vector 760 and the inertial sensor inputs 710 detects that the robot is in free-fall. When free-fall is detected in flow decision 1010, the robot will transition to balance mode. Once in balance mode, the robot can leave balance mode when the angle is detected to exceed a predetermined angle in flow decision 1020. This approach provides a seamless and novel method for instantiating balance control that gives a perception of understanding of the operator's intention.

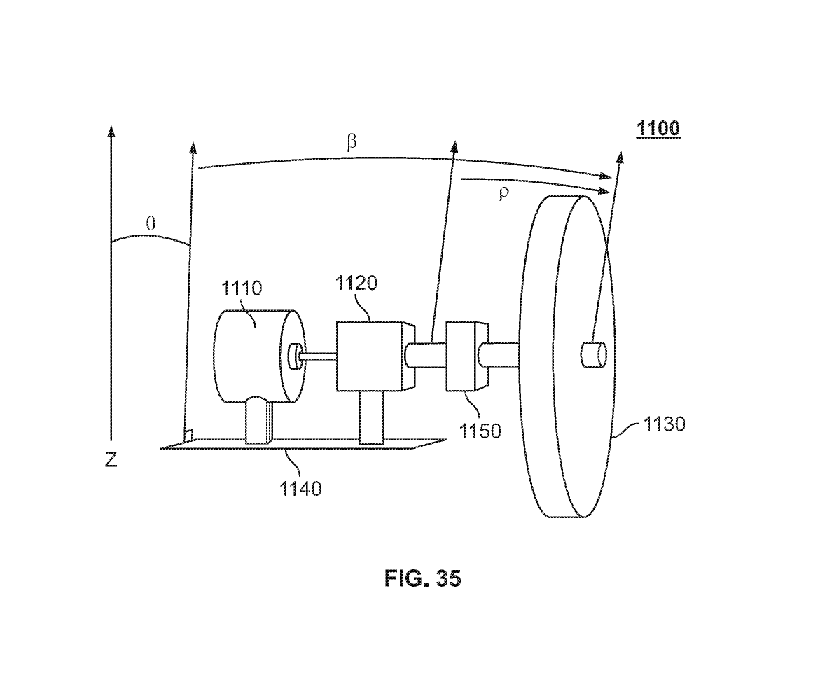

Referring also to FIG. 35, one of the biggest sources of non-ideality in the modeling and control of a balancing robot is the backlash in the gear train. In the present invention, the backlash is modeled as non-linear spring 1150 to simulated dead band between the wheel 1130, and an ideal zero-backlash gear train 1120. Assuming the motor 1110 input is a PWM command, the spring constant of non-linear spring 1150 models the compliance of the motor 1110 due to the motor current and the force constant. Here the motor current is modeled as the potential difference between the back EMF and the PWM command across the internal winding resistance of the motor 1110. Or, the motor current may be known as the set-point to the motor current subloop. In this way, the robot model closely predicts the actual robot behavior to account for backlash. Once in the model, the control loop is then used with an additional state to keep the robot stable. This accurate modeling further assists the punch classification by providing a more accurate differential state vector.

A further method of this invention is to model the gear-train backlash by a torsional spring 1150 between the gearbox 1120 and wheel 1130. This method accounts for gear backlash without modeling the nonlinear backlash gap. In this technique, the torsional spring constant, results in a torsional angle that generally approximates the backlash gap, and thereby adequately models the robot dynamics.

A further feature of the present invention is the use of a low-cost, high-bandwidth, current feedback sub-loop closed by the on-board microcontroller in combination with a low-inertia gear train. This combination further mitigates the effects of backlash, which as mentioned above, is the number one non-ideality in balancing robot dynamics that limits performance. Although current feedback is known to those familiar with the art, the specific application of a current-control loop to overcome gear backlash in a balancing robot is novel. A further feature of the invention is that the current loop is made to be inexpensive by virtue that the loop is closed in software. In the present invention, a high-bandwidth current measurement is taken by analog to digital conversion at a high sample rate. The motor PWM is then controlled by the software control loop to attain a current set point. This becomes a sub-loop where the outer balancing loop programs said current set point in order to control the robot. The current control sub-loop of the present invention provides several benefits. One benefit of the present invention is that the effects of gear train backlash are mitigated. This occurs because the electric motor current adjusts the armature force in a substantially linear fashion, and substantially independent of motor speed. Thus when a motor current is programmed, the motor will advance at a speed such as to apply the force as prescribed by the programmed current. If the direction of current reversed, the motor will accelerate rapidly to take up any gear train backlash so as to apply said force. A further feature of the invention is that implementation by software is relatively inexpensive compared to the hardware equivalent. A further feature of the invention is that the system is made practical by careful design of the loop bandwidth of the current control loop. Here the loop bandwidth is chosen to be sufficiently high to adequately overcome gear backlash, while not too high so as to require expensive processing power.

Taking a fall is a dramatic part of boxing. A balancing robot can choreograph a variety of falls due to its inherent instability. Each of the following falls can be randomized in selection and intensity, creating a different and dramatic fall every time. Prior to the fall, the robot can be programmed to move back or turn slightly while the balance algorithm continues to run. After an optional pre-fall move a fall motion occurs. Each of fall motions are initiated after the balance algorithm is stopped. By driving both motors forward, the robot will be made to fall backwards. By driving both motors backward the robot can be made to fall forward. Both of the previous falls can be varied with motor speed, causing slow or fast falls. By stopping both of the motors completely, a slow and random direction collapse occurs. By driving the motors in a right or left turn, the robot can make a spinning fall in either direction. An additional range of falls can be made by leaving the balancing algorithm running, but with gains set to levels that ensure an eventual fall.

An endurance algorithm can be implemented to measure the amount of simulated energy the robot has used. Punches can have different levels of force. High force punches use more endurance. Low force punches use less endurance. As the endurance usage escalates the robot can start to change behavior in various ways. Each of the following options can be randomized in selection and intensity, creating a different reaction, that can seem more lifelike due to its unpredictability. The robot can start to punch slower as endurance is used; similarly the robot can punch with less force. The maximum speed of the robot can be reduced. The swagger that was added to the balance algorithm can be reduced to zero, making the robot appear to be less energetic. In addition, during movement of the robot if over a specified period of time a robot is not using energy and simply dancing or paused simulated energy may begin to build up over time allowing the robot to increase or recover some of its endurance. This can allow a robot to regain strength and swagger.

The head connection to the robot torso is allowed to rotate right to left a small amount. This allows the head to randomly move right and left and the robot moves, making the robot seem more alive. Additionally, punches to the head can cause the head to turn in reaction to the punch, adding more realism. The head can also be attached in a manner that allows the head to be knocked off. A hard enough punch to the head or the robot or body of the robot could cause the head to come off.

In reference to FIGS., there is provided a robot 100. The robot 100 includes a body 110 defined to have an upper body portion 114 and a lower body portion 118. The robot 100 further includes a control system 120 attached to the body 100, which includes a programmable circuit board to receive a set of pre-programmed instructions and pre-programmed algorithms to control the movement and actions of the robot. The control system further includes a receiver (wirelessly or wired) configured to receive movement actions from a remote control 200 (wirelessly connected to the control system or hard wired with a tether into an input port. The control system 120 further having at least one axis of inertial sensing to support balancing of the robot in an upright configuration. The robot further includes two wheel assemblies 130 attached to the lower body 118. Each wheel assembly includes a wheel 134 independently controlled with a rotating motor 138. Each wheel is positioned for contact with a surface to control movement of the robot. The robot 100 further includes at least two arm assemblies 140 separately attached to the upper body portion 114. Each arm assembly 140 includes an arm 144 independently controlled with rotating motors 148.

The robot may further include at least two leg assemblies separately attached to either the upper body portion—below the arm assemblies or attached to the lower body portion above or adjacent to the wheel assemblies. Each leg assembly would be controlled with the use of rotating motors and posed to strike out and up as a kickboxer would strike in a fight.

The preprogrammed algorithms are configured to include a balance algorithm to (a) maintain the robot in an upright configuration during movement and actions of the robot, (b) cause the robot to maintain an upright configuration upon sensing an impact or force onto the robot, (c) cause the robot to fall into a prone configuration on a surface upon sensing either a strong impact or force (defined above a threshold impact or force) onto the robot or sensing repeated impacts above a threshold number of impacts, and (d) create specified movement of the robot to mimic swagger, loss of energy or endurance, and additional wobble to imitate being dazed. The set of preprogrammed instructions configured to include movement instructions defined to: (a) control the wheels to move the robot forward, backward, left and right, and (b) control the arms to move one or both of the arms upward, downward, in a partial or full forward extension and in a partial or full backward contraction to mimic punching.

Alternate embodiments. The described embodiment is made to be human like in shape and arm movement. Additional embodiments can alter the fighting style while using all the same features as described previously

As described previously is a Boxer with two similar arm motions providing a forward punch with adjustable up and down punch positioning.

Alternate 1—Boxer with two different arms. One arm is changed to punch across with adjustable right to left punch positioning.

Alternate 2—Robotic Boxer with non-human like weapons and attachments. Options include a hammer arm that is purely rotary without an elbow joint, a grappling arm, etc.

Alternate 3—Knight with two different arm motions and attachments. Sword arm and shield arm. The sword can be a top down swing, or a side swing. The shield movement is a forward and up movement, allowing for both blocks and bashing the opponent with the shield.

Alternate 4—A soldier with a human like arm with shoulder and elbow, with a knife in his hand. The other hand is a stationary sub-machine gun.

List of Algorithms

Finite Difference—this provides approximations to derivatives of functions.

Discrete Integral—this algorithm provides a discrete-time approximation to an integrator.

Reciprocal Square Root—fast method of computing the reciprocal square root of a floating point number.

Extended Kalman Filter—This is a linearized state-variable, optimal estimation filter for non-linear systems.

PID controller—this is a compensation technique for use in a closed-loop control system.

Differential State Vector Punch Classifier—this is an algorithm of the present invention in which a difference between the predicted next-state and the measured next state is used to classify external stimulus to determine its nature.

Laplace Transform—is a method of solving differential equations using algebraic equations.

Lagrangian Mechanics—is a method of solving for the equations of motion of a system with holonomic constraints in generalized coordinates.

Endurance Algorithm—a method of this invention to quantify each punch thrown to simulate the sum of the energy expended over a period in order to estimate endurance.

Balance Algorithm—A method of closing a feedback loop upon the sensor measurements and actuators such that one or more parameters are maintained to adjustable set points. The controlled parameters include but are not limited to, angle of center of mass about axel with respect to vertical, wheel velocity, damping factor, gyroscope offset angle, and gyroscope rate drift offset.

Fall Algorithm—a method of this invention whereby normal control inputs and/or normal loop compensation parameters are overridden in a predetermined pattern so that the robot is made to fall in a realistic and/or dramatic manner.

Anti-Backlash, Current Control Subloop Algorithm—an algorithm of this invention whereby the backlash in the drive gear-train is automatically taken up by high-bandwidth control of the current to the associated drive motor.

Shut-down algorithm—an algorithm of this invention that detects when balancing has ceased, and transitions the robot to the idle state with the motors and actuators disabled.

Instantiation algorithm—an algorithm of this invention that detects the gestures and intention of the operator to cause the robot to transition into the balance state at precisely the right moment so as to be seamless and natural.

Backlash model algorithm with gap model—an algorithm of the present invention that models gear-train backlash as a tortional spring between the gearbox and wheel and further includes a model of the backlash gap.

Backlash model algorithm—an algorithm of the present invention that models the gear-train backlash as a highly damped tortional spring between the gear-train and wheel without the use of a non-linear backlash gap model.

Current Control Algorithm—an algorithm of this invention used to maintain the motor current at a variable set-point.

Punch detector algorithm—an algorithm of this invention whereby one or more magnetometers are used to measure the signature and proximity magnets in the opponent's fist to determine the exact nature of the measured punches.

Proximity-informed command override algorithm—an algorithm of this invention whereby a method of proximity detection is used to prevent user commands from causing a loss of balance.

Wobbling algorithm—an algorithm of this invention to cause the robot to appear dizzy or unsteady by imparting either over random signals to the drive motors, or by adjusting the compensator parameters to deliberately create underdamping of the control loop, or both.

Damage detection algorithm—an algorithm of this invention to sum the quantitative measurements from a punch detector algorithm to estimate the sum (extent) of simulated damage received in an interval.

Damage behavior algorithm—an algorithm of this invention to create observable, realistic, stylistic behaviors appropriate to the amount of simulated damage the robot has received in an interval.

Erratic injector algorithm—an algorithm of this invention that adds small amounts in forward or reverse movement to the output of the balance algorithm.

Dancing, Bobbing, Weaving algorithm—an algorithm in this invention whereby various command inputs are varied in a random and/or predetermined pattern to create realistic and/or stylistic boxing moves.

Feedforward punch compensation algorithm—an algorithm of the present invention whereby the known position, acceleration, and current profile of each predetermined punch type is used to counteract the impulse that would otherwise excite the control loop causing unwanted oscillatory, reactive motion. Expected current is compared to measured current to estimate the strength of impact so as to anticipate and counteract the punch impulse.

While the instant invention has been shown and described in accordance with a preferred and practical embodiment thereof, it is recognized that departures from the instant disclosure are contemplated within the spirit and scope of the present invention.

We claim:

1. An improved balance algorithm utilized to control and maintain a robot in an upright standing position while stationary and moving, the balance algorithm having a combination of the following sub-algorithms:
an erratic injector movement algorithm configured to add forward, reverse, right, and left directional movements to the improved balance algorithm of the robot to mimic swagger;
punch detection algorithm configured to detect an impact received by the robot and/or an impact transmitted by the robot onto a surface;
an endurance algorithm configured to measure an amount of simulated energy used by the robot, such that the improved balance algorithm receiving data from the endurance algorithm is further configured to slow movement based on the amount of simulated energy used or increase movement based on the amount of simulated energy conserved; and
an intentional fall algorithm configured to control and reduce movement of the robot in a predetermined pattern to cause the robot to fall over in a realistic dramatic manner.

2. The improved balance algorithm of claim 1, wherein the erratic injector movement algorithm is further configured into a pattern of movement to mimic a swagger dance.

3. The improved balance algorithm of claim 1, wherein the robot includes at least one articulated appendage in communication with the punch detection algorithm, the at least one appendage having a controlled mechanical profile extension monitored by the punch detection algorithm, such that when the at least one appendage impacts a surface, the punch detection algorithm is configured to determine a current difference between a full extension and a shortened extension of the controlled mechanical profile extension caused by the impact onto the surface and wherein the punch detection algorithm is further configured to determine a strength and duration of the impact onto the surface.

4. A robot comprising:
a pair of legs, each leg independently having at least one wheel in contact with a surface for movement, the at least one wheel is further in communication with a motor configured to control the movement of the leg connected thereto, the pair of legs attached to a torso having at least one controlled mechanical arm configured with a profile extension;
a balance algorithm to control movement of the two wheels such that the robot is configured to maintain an controlled upright position;
a punch algorithm in communication with the balance algorithm and the at least one controlled mechanical arm, the punch algorithm configured to monitor the profile extension to determine if an impact onto a surface landed by the at least one controlled mechanical arm;
a damage detection algorithm configured to monitor and detect an impact of an external force received by the robot; and
a fall algorithm in communication with the damage detection algorithm and the balance algorithm configured to cause the robot to fall from the upright position to a prone position when an amount of damage received exceeds a predetermined threshold.

5. The robot of claim 4 further comprising:
an erratic injector movement algorithm in communication with the motors and configured to add forward, reverse, right, and left directional movements to the legs of the robot to mimic swagger.

6. The robot of claim 5 further comprising:
an endurance algorithm configured to measure an amount of simulated energy used by the robot, such that the balance algorithm receiving data from the endurance algorithm is further configured to slow movement of the legs and the at least one controlled mechanical arm based on the amount of simulated energy used or increase movement based on the amount of simulated energy conserved.

7. The robot of claim 6 further comprising:
a feedforward punch compensation algorithm configured to adjust the balance algorithm when the at least one controlled mechanical arm is extended to punch a surface to maintain a more stable upright position.

8. A robot comprising:
a body defined to have an upper body portion and a lower body portion;
a control system attached to the body and having a programmable circuit board to receive a set of pre-programmed instructions and pre-programmed algorithms to control the movement and actions of the robot; the control system further having a receiver (wirelessly or wired) configured to receive movement actions from a remote control (wirelessly connected to the control system or hard wired with a tether into an input port); the control system further having at least one axis of inertial sensing to support balancing;
two wheels independently controlled with rotating motors and separately attached to the lower body portion; each wheel is positioned for contact with a surface to control movement of the robot;
at least two arms independently controlled with rotating motors and separately attached to the upper body portion;
the preprogrammed algorithms configured to include a balance algorithm to:
(a) maintain the robot in an upright configuration during movement and actions of the robot,
(b) cause the robot to maintain an upright configuration upon sensing an impact or force onto the robot,
(c) cause the robot to fall into a prone configuration on a surface upon sensing either a strong impact or force (defined above a threshold impact or force) onto the robot or sensing repeated impacts above a threshold number of impacts, and
(d) create specified movement of the robot to mimic swagger, loss of energy or endurance, and additional wobble to imitate being dazed; and
the set of preprogrammed instructions configured to include movement instructions defined to:
(a) control the wheels to move the robot forward, backward, left and right, and
(b) control the arms to move one or both of the arms upward, downward, in a partial or full forward extension and in a partial or full backward contraction to mimic punching.
